(19) United States
(12) Patent Application Publication
(10) Pub. No.: US 2018/0227125 A1
(43) Pub. Date: Aug. 9, 2018

(54) MULTI-USE LONG STRING ANTI-TAMPERING AUTHENTICATION SYSTEM

(71) Applicant: ATF CYBER, INC., Issaquah, WA (US)

(72) Inventor: Terry L. Davis, Issaquah, WA (US)

(21) Appl. No.: 15/944,778

(22) Filed: Apr. 3, 2018

Related U.S. Application Data
(63) Continuation-in-part of application No. 15/604,610, filed on May 24, 2017.
Application No. 15/604,610 is a continuation of application No. 14/821,610, filed on Aug. 7, 2015, now Pat. No. 9,692,598.
(60) Provisional application No. 62/481,066, filed on Apr. 3, 2017.

(51) Int. Cl. H04L 9/32; H04L 9/08; H04L 29/06

(52) U.S. Cl. CPC H04L 9/32; H04L 9/0894; H04L 63/08; H04L 63/10; H04L 9/3247

(57) ABSTRACT

This disclosure describes systems and methods for implementing techniques that use multi-use long string authentication keys to protect the transfer of data resources from a sending device to a recipient device. More specifically, an anti-tampering authentication application is described that may reside on client devices that send and receive data resources. An anti-tampering authentication application, on a sending device, may generate a protected data resource by mathematically coupling an authentication key with a data resource intended for delivery to a recipient device. The anti-tampering authentication application may also generate computational instructions that automatically decouple the protected data resource from the authentication key in response to a successful authentication of an authentication string at the recipient device. Additionally, the anti-tampering authentication application, on the recipient device, may execute the computational instructions and automatically decouple the authentication key from the protected resource, in response to a successful authentication of the authentication string.

### RELATED APPLICATIONS

This application claims the benefit of co-pending, commonly owned U.S. Provisional Patent Application No. 62/481,066 filed on Apr. 3, 2017, titled “Multi-use long string anti-tampering authentication system,” and is a continuation-in-part of a co-pending, commonly owned U.S. patent application Ser. No. 15/604,610 filed on May 24, 2017, titled “Multi-Use Long String Authentication Keys,” which is a continuation of a commonly owned U.S. patent application Ser. No. 14/821,610 filed on Aug. 7, 2015, now U.S. Pat. No. 9,692,598, titled “Multi-Use Long String Authentication Keys,” which are herein incorporated by reference in their entirety.

### BACKGROUND

Throughout history, keys have provided an inexpensive, though imperfect, method of access control to physical properties such as buildings, vehicles, containers, safes, and the like. Physical keys use unique authentication geometries to operate a specifically paired-lock or a small number of specifically paired-locks. Current methods of generating key authentication geometries are governed by efficiency requirements that focus on fabricating, managing and storing individual key solutions. However, the sheer proliferation of personal items requiring access control raises concerns over unintended key duplication. In more recent times, the advent of a fob key has somewhat eased those concerns. Fob keys include small security hardware devices that use a built-in authentication string. However, the methodology of generating authentication strings has been developed with the same reasoning as their predecessor technologies; namely to allow for an efficient means to fabricate, manage and store individual key solutions. As a result, with the ever-increasing number of physical items requiring access control, concerns over unintended duplication of authentication strings is becoming more prevalent.

### SUMMARY

This disclosure describes systems and methods for implementing an authentication technique using one or more multi-use long string authentications keys. The multi-use long string authentication keys, hereinafter “authentication keys,” can provide a computationally efficient method of authenticating access to protected resources. The authentication technique is based on a shared knowledge of at least one authentication key. The authentication key is used as a platform to derive authentication strings that authenticate a client device for access to one or more protected resources. An authentication string may comprise of any number of characters, he character length of which can be designed to accommodate an authentication need, a required level of security, a device size, a size of the authentication key, or any combination thereof The authentication key may vary in size from a few bits to terabytes or petabytes in length. The authentication strings derived from authentication keys can be used to control access to various types of protected resources such as, but not limited to, a digital access mechanism for a residential or commercial building, a vehicle fob key, a remote garage door opener, a hotel room card key, credit or debit cards magnetic strip or chip, online financial accounts, computer or control systems, or website authentication. In various examples, a protected resource may comprise of any “physical resource” or “digital resource” that may control access.

This disclosure further describes systems and methods for implementing techniques using multi-use long string anti-tampering authentication keys. Specifically, this disclosure describes systems and methods for implementing techniques that use multi-use long string authentication keys to protect the transfer of a data resource between a sending device and a recipient device. In various examples, the data resource may include data files, multimedia files, application files, or any other type of data packet that can be transferred between a sending device and a recipient device, via one or more networks.

This Summary is provided to introduce a selection of concepts in a simplified form that are further described below in the Detailed Description. This Summary is not intended to identify key features of the claimed subject matter, nor is it intended to be used as an aid in determining the scope of the subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference number in different figures indicate similar or identical items.

FIGS. 1A and 1B illustrate example implementations of a client device requesting access to a protected resource using a multi-use long string authentication key. In FIG. 1A, a client device transmits an authentication request to a protected resource that includes an authentication system. In FIG. 1B, the client device transmits an authentication request to an authentication system that is independent of the protected resource.

FIG. 2A and 2B illustrate authentication techniques used to derive an authentication string from an authentication key. In FIG. 2A, an authentication string is derived using an authentication key and authentication parameters that include a key index parameter, and a key length parameter. In FIG. 2B, an authentication string is derived using an authentication key and authentication parameters that include a key index parameter, a key length parameter, and a key offset parameter.

FIG. 3 illustrates a block diagram of a process of deriving an authentication string from a plurality of authentication keys.

FIG. 4 illustrates a block diagram of a process of deriving an authentication string from a plurality of authentication keys.

FIG. 5 illustrates a block diagram of a first example of a sending device using an anti-tampering authentication application to transmit a protected data resource to a recipient device.

FIG. 6 illustrates a block diagram of a second example of a sending device using an anti-tampering authentication application to transmit a protected data resource to a recipient device.

FIG. 7 illustrates a block diagram of a third example of a sending device using an anti-tampering authentication application to transmit a protected data resource to a recipient device.

FIG. 8 illustrates an example architecture of an authentication system that controls access to a protected resource.

FIG. 9 illustrates an example architecture of a client device that requests access to a protected resource using a multi-use long string authentication key.

FIG. 10 illustrates an example flow of a process for granting access to a protected resource in response to receiving an access request from a client device that includes a client device identifier, a first authentication string, one or more authentication parameters, and a particular type of access request.

FIG. 11 illustrates an example flow of a process for granting access to a protected resource in response to receiving an access request from a client device that includes a client device identifier and one or more authentication parameters. FIG. 11 further describes determining access privileges using a key index table.

FIG. 12 illustrates an example flow of a process for granting access to a protected resource in response to receiving an access request from a client device that includes a client device, and a particular type of access request.

FIG. 13 illustrates an example flow of an anti-tampering authentication application that generates a protected data resource that is intended for delivery to a recipient device.

FIG. 14 illustrates an example flow of an anti-tampering authentication application that mathematically decouples the data resource from the authentication based on successfully validating an authentication string using the authentication key.

FIG. 15 illustrates an example flow of an authentication system that grants access to a protected resource to response to deriving an authentication string from multiple authentication keys.

### DETAILED DESCRIPTION

This disclosure describes a multi-use digital authentication scheme that provides client devices with access to protected resources. The authentication scheme is based on a shared knowledge of at least one long string authentication key between an authentication system and a client device. The authentication key may be used as a platform to derive authentication strings that authenticate individual client devices for access to protected resources. In some examples, authentication strings may be associated with a restricted type of access to the protected resource. In other examples, the authentication strings may be associated with unrestricted access to the protected resource.

The authentication key can be generated by any method that can produce a long string of random characters. In various examples, a character may include a letter, numerical digit, common punctuation mark, whitespace, or a non-printing character used for in-band signaling to cause effects other than the addition of a printed symbol. Examples of non-printing characters include control characters in ASCI, such as C8 control code (i.e. backspace) that is used to either erase the last character printed or to overprint it. The term “long string” as used herein describes a specific number of characters of an authentication key that is equal to or exceeds a number of characters associated with an authentication string. As a non-limiting example, an authentication string may comprise of five characters or five bits in length. In this instance, a corresponding “long string” authentication key may constitute six characters or six bits, or any other number of characters that is at least five characters or five bits. As described herein, a long string can be defined by a specific number of characters or a specific number of bits. In some examples, the authentication key is initially derived by a client device and shared with an authentication system. In other examples, the authentication key may be derived by the authentication system and shared with the client device. In one example, the authentication key can be generated using a mathematical random number generator. In another example, the authentication key can be generated by coding environmental data, such as, but not limited to, background radiation, background noise from a particular geolocation (i.e. busy street), physical baseband spectrum noise, and sunlight wavelength. In yet another example, an individual user of a client device can generate an authentication key by coding individual pixels in a particular digital photo, a specific text from a particular publication, or an audio excerpt from particular composition or digital recording. In other words, the authentication key can be generated by any means that digitally encodes data into a long string of characters that is unique to a moment in time, an environmental condition, an individual user, or any combination thereof.

In response to generating an authentication key, the authentication key can be shared between the client devices requesting access to a protected resource and the authentication system that controls access to the protected resource. In doing so, the authentication key becomes the common platform by which one or more unique authentication strings can be derived.

In various examples, one or more authentication keys can be used as a common platform to derive unique authentication strings for multiple protected resources. In a non-limiting example, a single authentication key may be associated with a client device and the authentication key can be used to derive authentication strings for a range of protected resources, such as, but not limited to, commercial and residential building access, vehicle access and operation, and access to financial resources. In another example, a particular authentication key may be associated with one protected resource. Additionally, or alternatively, multiple authentication keys may be used in combination to access one protected resource.

In various examples, a request to access a protected resource may be accompanied by a client device identifier associated with a client device. The client device identifier can be used by the authentication system to identify one or more authentication keys that correspond to the client device. In some examples, an authentication system may be tasked with authenticating access of several, if not millions of users. In this instance, the client device identifier can efficiently identify one or more authentication keys associated with the client device, from multiple (e.g., millions) of authentication keys, thus streamlining the authentication process. Note that a same client device may share multiple authentication keys with an authentication system. Thus by extension, a same client device may have multiple client device identifiers. This is because each authentication key may associate a particular client device with a particular protected resource. If a client device accesses multiple protected resources, then each protected resource will likely have its own unique authentication key, or unique combination of authentication keys. Thus, the client device may likely retain multiple client device identifiers to identify the one or more authentication keys associated with a particular protected resource.

In various examples, a request to access a protected resource can also include a request to exercise different access privileges. For example, an authentication system may derive one or more authentication strings—via one or more authentication keys—that are associated with a single protected resource, with each authentication string corresponding to a different access privilege. In a non-limiting example, consider access requests received by a financial institution. An access request may involve accessing balance information of financial resources held within the financial institution. Alternatively, an access request may involve performing financial transactions using those same financial resources. In this example, two different authentication strings may be associated with the financial institution to separately provide access to balance information and perform financial transactions. In another example, the protected resource may correspond to a hotel room. In this example, different authentication strings may be associated with different entities, such as, hotel guests, housekeeping, a front desk manager, and a hotel manager. Thus, a particular access privilege may be associated with each of the hotel guests, housekeeping, front desk manager, and hotel manager. For instance, an authentication string may associate hotel room access for housekeeping during particular working hours.

In another example, the protected resource may correspond to a vehicle, and different authentication strings may be associated with different levels of vehicle access. For example, a first authentication string may grant vehicle access during daylight hours, while a second authentication string may allow unlimited vehicle access.

In other examples, the protected resource may correspond to a residential building, a commercial building, or an industrial complex such as power grid sub-stations. Accordingly, different authentication strings may be associated with maintenance personnel, security personnel, and building residents. Accordingly, each authentication string may be associated with a different level of access. For instance, maintenance personnel and security personnel may be afforded temporal building access, whilst building residents may be afforded unlimited access.

In another example, the protected resource may correspond to an aircraft or an unmanned aerial vehicle (UAV), and different authentication strings may correspond to different entities that exercise control over the aircraft or UAV. These entities may include an airport control tower, the federal aviation administration (FAA), and maintenance personnel. Accordingly, the different authentication strings may be associated with different levels of control over aircraft systems for each of the entities.

In yet another example, the protected resource may correspond to a business, government, or private or public computing system. Accordingly, different authentication strings may be associated with access privileges associated with employees, customers, partners, etc.

In various examples, the request to access a protected resource can also include one or more authentication parameters. The one or more authentication parameters can be used to derive or validate an authentication string from an authentication key. The one or more authentication parameters can include, but are not limited to, a key index parameter, a key offset parameter, and a key length parameter, an index direction parameter, and an authentication key identifier parameter.

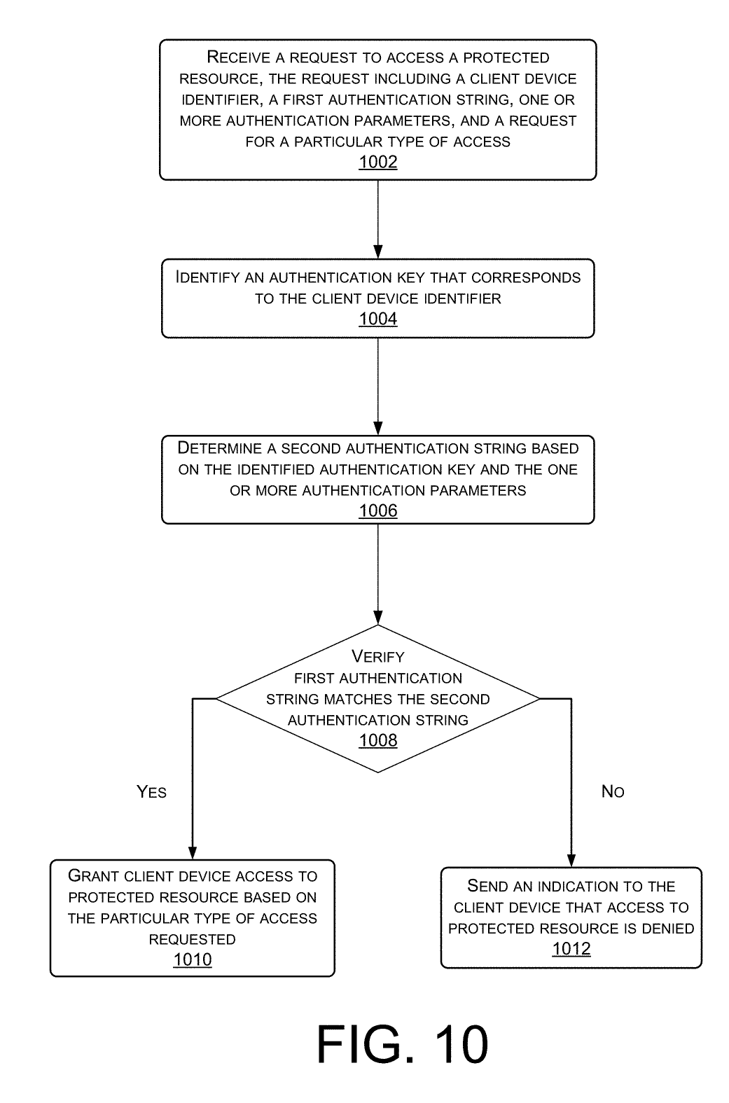

Moreover, a request to access a protected resource can include different combinations of the information. In one non-limiting example, an access request may include a client device identifier, one or more authentication parameters, an authentication string, and a particular type of access request. In this example, the authentication system can use the client device identifier to identify a corresponding authentication key that is stored within the authentication system. The one or more authentication parameters can then be used to derive an authentication string from the identified authentication key, and further verify that the derived authentication string matches the authentication string that accompanied the request. In response to verifying that both authentication strings match, the authentication system can grant the client device the access to the protected resource based on the type of access requested. A flow chart of this example authentication scheme is described in more detail in FIG. 10.

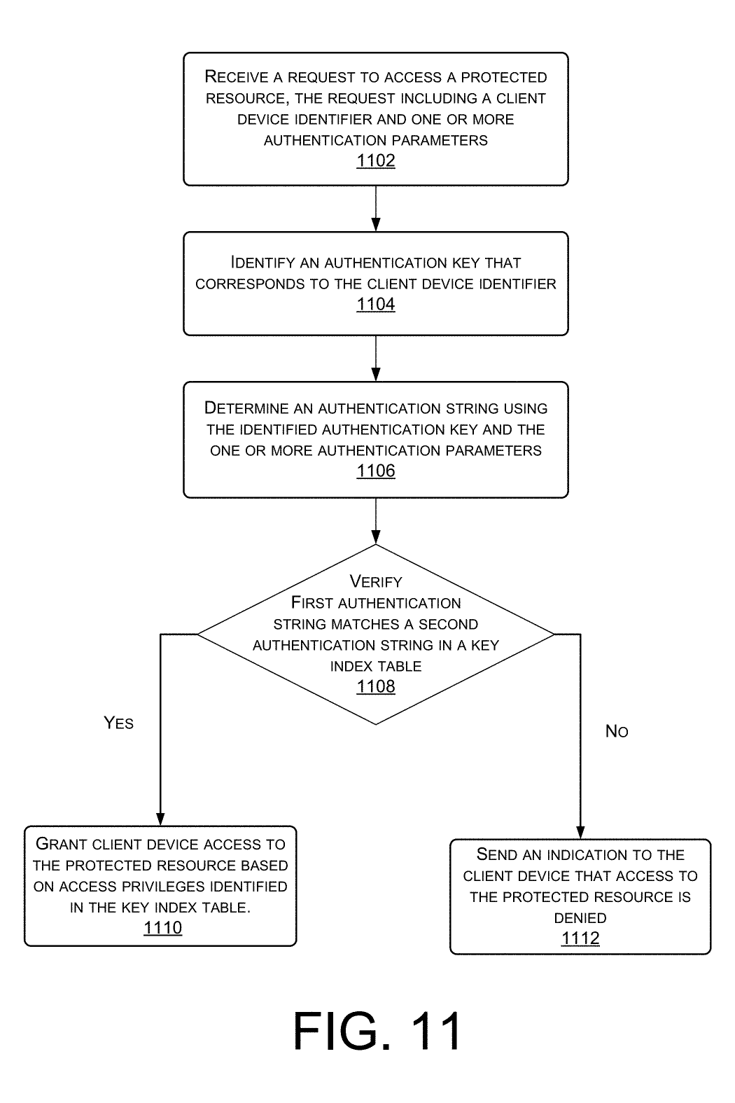

In another example, a request to access a protected resource can include a client device identifier and one or more authentication parameters. In this example, the authentication system can use the client device identifier to identify a corresponding authentication key stored within the authentication system. The one or more authentication parameters may be used to derive an authentication string from the identified authentication key. The authentication system may compare the derived authentication string to an index table of authentication strings that are stored within the authentication system. In doing so, the authentication system can validate an authenticity of the derived authentication string and identify a corresponding access request (e.g., opening a vehicle door or starting a vehicle engine) that is associated with the authentication string. A flow chart of this example authentication scheme is described in more detail in FIG. 11.

In some examples, rather than using one or more authentication parameters to derive an authentication string from an authentication key, the entire authentication key may itself constitute an authentication string. In this instance, a request to access a protected resource need only include a client device identifier and an authentication key. Here, the authentication system may use the client device identifier to identify a corresponding authentication key stored within the authentication system. Access to the protected resource is then based on a comparison of the authentication key provided with the access request and the corresponding authentication key stored within the authentication system.

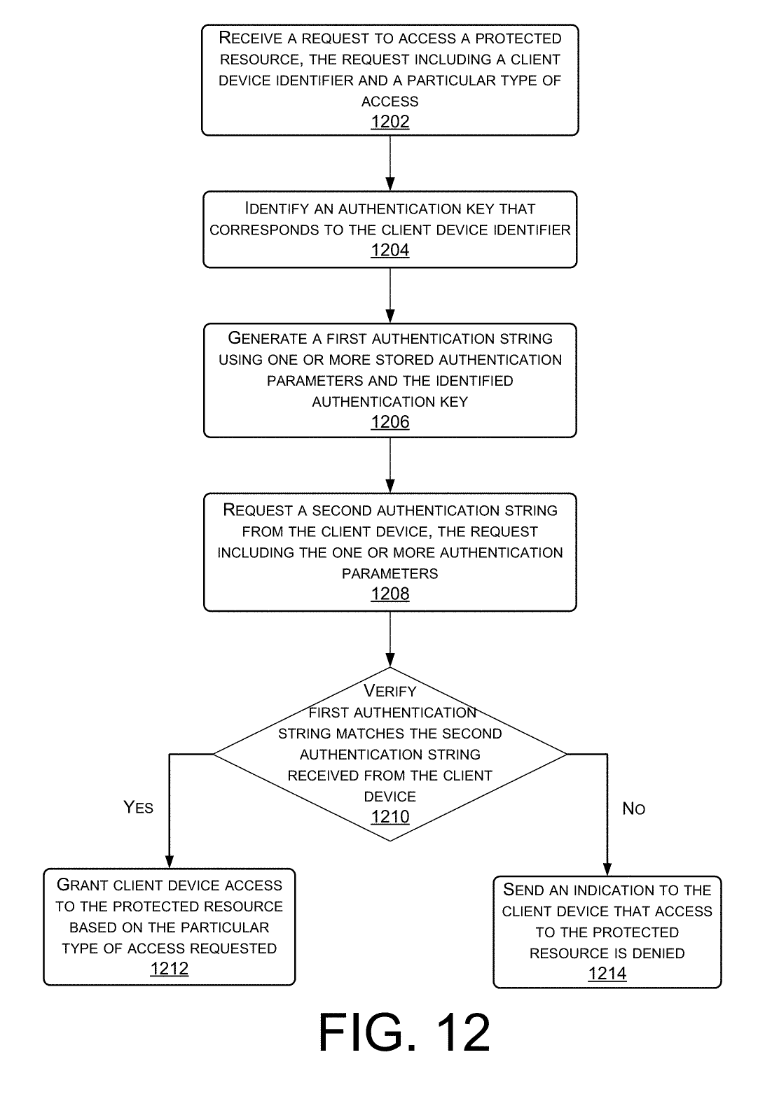

In some examples, a request to access a protected resource can include a client device identifier and a request for a particular type of access. In this example, the authentication system can use the client device identifier to identify a corresponding authentication key stored within the authentication system. The authentication system may also determine one or more authentication parameters and derive an authentication string based on the one or more authentication parameters. In doing so, the authentication system may transmit an indication to a client device requesting an authentication string based on the one or more authentication parameters. In response, the client device can reply with a derived authentication string, to which the authentication system can determine whether to grant access to the protected resource. A flow of this example authentication scheme is described in more detail in FIG. 12.

In various examples, the authentication techniques described herein can facilitate access control for protected resources that include, without limitation, a digital access mechanism for a residential or commercial building, a vehicle fob key, a remote garage door opener, a hotel room key, and credit or debit financial accounts. Other examples, include control systems, software applications, website-based applications, or any other computing system or application that relies on digital authentication.

Additionally, this disclosure describes an anti-tampering authentication application that facilitates transmission of a protected resource between client devices. Particularly, the authentication scheme is based on a shared knowledge of the long string authentication key between the sending device and a recipient device.

In various examples, the anti-tampering authentication application may generate a protected data resource by mathematically coupling the authentication key with a data resource that is intended for delivery to a recipient device. In this instance, the protected data resource is inaccessible by any client device until first uncoupled from the authentication key. Thus, the anti-tampering authentication application may generate computational instructions that automatically decouple the protected data resource from the authentication key in response to a successful authentication of an authentication string at a recipient, client device. In various examples, the authentication string may be derived using the same authentication key coupled to the protected data resource.

Moreover, the anti-tampering authentication scheme may use one or more authentication parameters to derive or validate an authentication string from an authentication key. The one or more authentication parameters may include, but are not limited to, a key index parameter, a key offset parameter, a key length parameter, or an index direction parameter, and an authentication key identifier parameter.

The key index parameter may identify a character position within the authentication key that corresponds to a first character of the authentication string.

The key offset parameter can include a numerical value that identifies a next character of the authentication string within the authentication key. For example, a key offset parameter of 2 means that a subsequent character of an authentication string is identified as being offset by two character positions from the last identified character position within the authentication key.

The key length parameter may include a numerical value that denotes the number of characters that make up the authentication string. For example, a key length parameter of three hundred reflects an authentication string of three hundred characters. In one non-limiting example, the key length parameter can include any numerical value that is equal to or lesser than the character length of an authentication key. In another non-limiting example, the key length parameter may include a numerical value that is greater than the character length of the authentication key. In this instance, the authentication key may be configured to wrap from its last character back to its first character to handle a key length parameter that is greater than the character length of the authentication key. In doing so, the authentication key may handle a key length parameter of any length.

The index direction parameter may denote the direction in which a next character for an authentication string is selected from the authentication key. The index direction parameter may correspond to a forward index direction or a backward index direction. The backward index direction may indicate that a next character selection for an authentication string and from the authentication key, precedes the current character selection from the authentication key. Alternatively, a forward index direction may indicate that the next character selection for the authentication string and from the authentication key, proceeds the current character selection from the authentication key. In the absence of an index direction parameter value, the default setting may correspond to a forward index direction.

The authentication key identifier parameter may be used to identify a ‘long string’ authentication key within the authentication system. In this example, the authentication system may store multiple ‘long string’ authentication keys that are associated with a client device identifier, a protected resource, or a combination of both. The authentication key identifier parameter may be used to identify which authentication key, or authentication keys, are to be used to derive an authentication string that is associated with access to a protected resource.

A technical effect of transmitting a protected resource between client devices using an authentication key and one or more authentication parameters is that the data resource is inaccessible by any client device unless decoupled from the authentication in response to a validated authentication string. Further, an authentication string that is based on the authentication key presents a significant number of possible authentication combinations relative to traditional mechanisms of performing digital authentication. Further, the authentication process disclosed herein allows either party, the sending device, the recipient device, or anti-tampering authentication application, to update an authentication string if that party believes the security of the authentication string has been comprised. For example, since both the sending device and the recipient device share a common authentication key, each party may elect to change an authentication string by updating authentication parameters that are associated with the common authentication key. Provided each party uses the same authentication key and the same updated authentication parameters, each party may derive the same updated authentication string. In this instance, the updated authentication string may be used to decouple the same authentication key from the protected data resource. Thus, in circumstances where security measures have been comprised, an affected party need not wait for the other party to change an authentication string.

Moreover, the authentication key may be encoded as machine-readable data from random data (i.e. random numbers, environmental data or personal data) that is shared only between the sending client device and the recipient device. In doing so, the protected resources are provided with an additional level of protection based on the computational impracticability of duplicating a long string of characters that is unique to a moment in time, an environmental condition, an individual user, or any combination thereof.

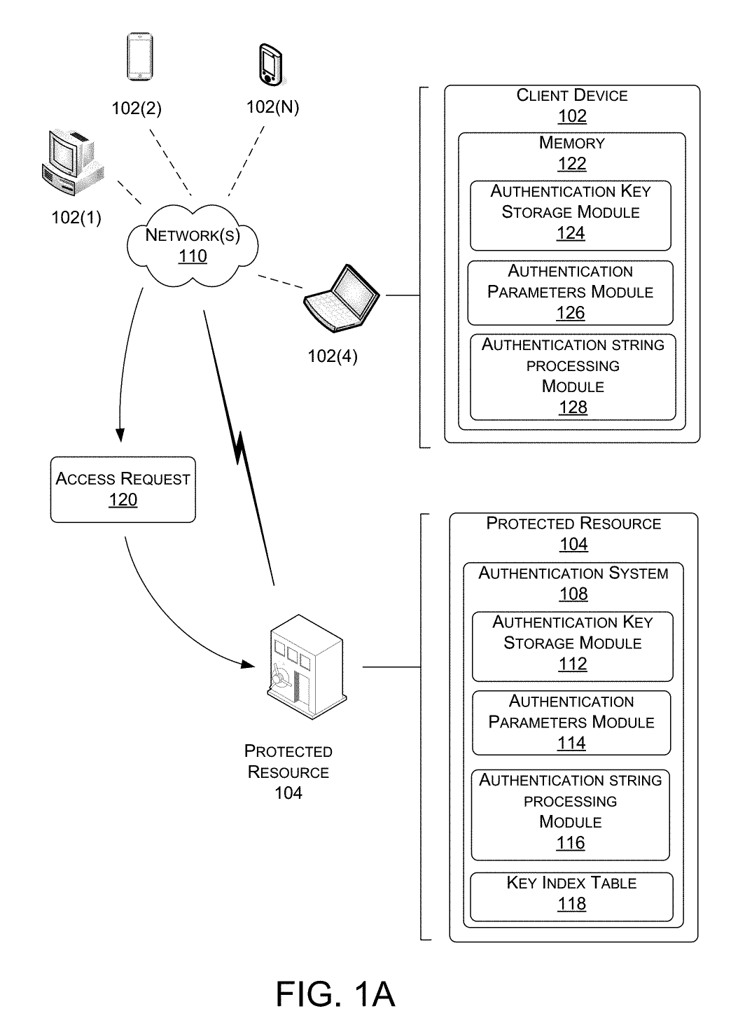

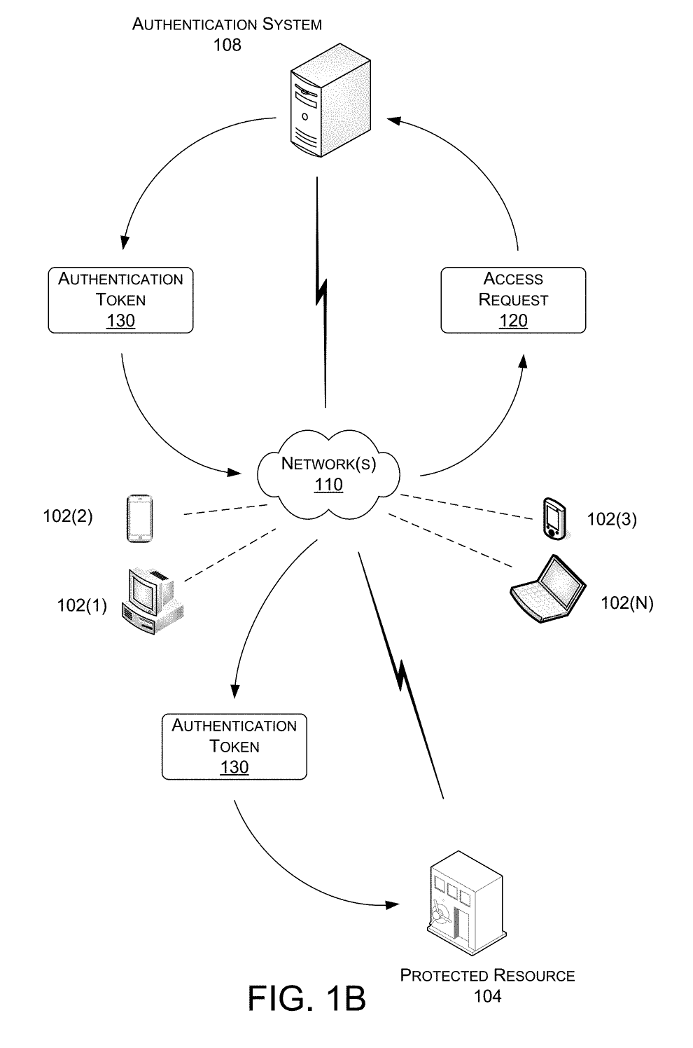

FIG. 1A illustrates an example implementation of client device(s) 102(1)-102(N) requesting access to a protected resource 104. In some examples, the protected resource 104 can include, but is not limited to, vehicles, buildings, garage doors, financial accounts at banking institutions, and computing system applications.

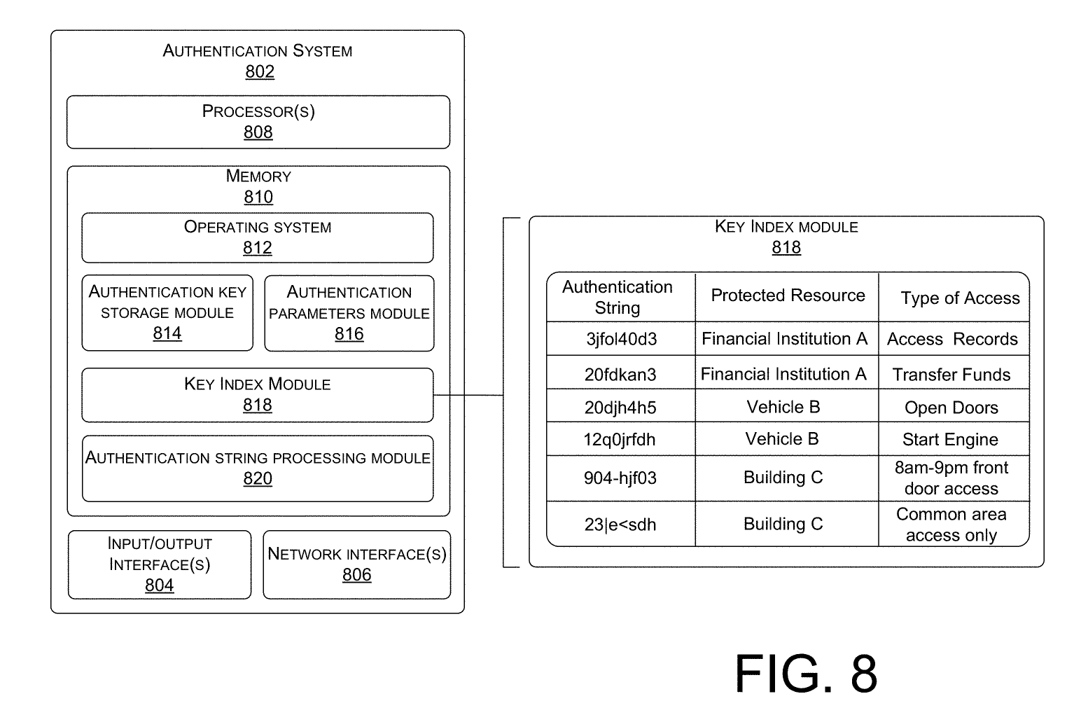

In the illustrated example, FIG. 1A depicts an authentication system 108 that is integrated with a protected resource 104. The authentication system 108 can include one or more modules, such as an authentication key storage module 112, an authentication parameters module 114, an authentication string processing module 116, and a key index table 118. The authentication key storage module 112 can store one or more authentication keys with associated client identifiers. Each authentication key and associated client identifier can correspond to different, client device(s) 102(1)-102(N). The authentication parameters module 114 can store one or more authentication parameters, which may be transmitted to one of the client device(s) 102(1)-102(N) as part of a request to one of the client device(s) 102(1)-102(N) to provide an authentication string. The authentication string processing module 116 can derive an authentication string from a stored authentication key using one or more authentication parameters that are provided with an access request 120. The key index table 118 can be used to correlate derived authentication strings with access privileges associated with the protected resource 104. The above referenced modules of the authentication system 108 are described in more detail below with reference to FIG. 8.

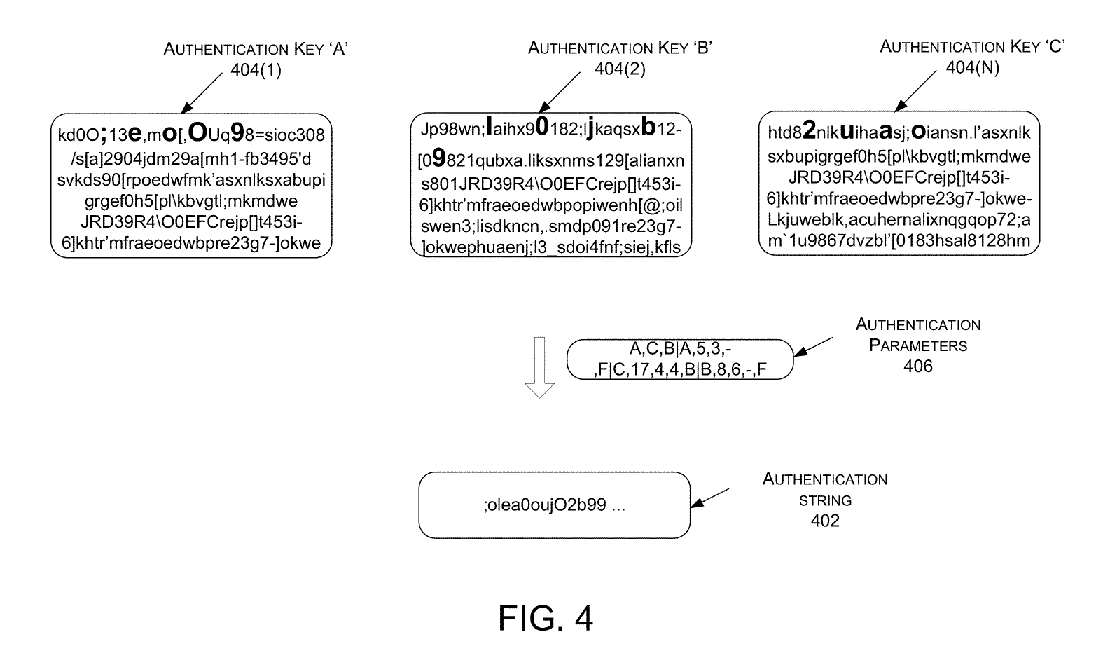

In the illustrated example, FIG. 1A depicts a diverse variety of client device(s) 102(1)-102(N) such as laptop computers, tablet computers, or cellular phones, but the client device(s) 102(1)-102(N) are not limited to a particular type of device. Client device(s) 102(1)-102(N) further comprises memory 122 that include one or more modules such as, but not limited to, an authentication key storage module 124, an authentication parameters module 126, and an authentication string processing module 128. The authentication key storage module 124 can store one or more authentication keys that are associated with different protected resources, such as the protected resource 104. The authentication parameters module 126 can store one or more authentication parameters, which can form part of an access request 120 to an authentication system 108. The authentication string processing module 128 can derive an authentication string from a stored authentication key using one or more authentication parameters. The above referenced module of the client device(s) 102(1)-102(N) are described in more detail below with reference to FIG. 4.

The client device(s) 102(1)-102(N) and the authentication system 108 can communicate via one or more network(s) 110. The one or more network(s) 110 can include public networks such as the Internet, or private networks such as an institutional and/or personal intranet, or some combination of private and public networks. Networks can include any type of wired and/or wireless network, including but not limited to local area network (LANs), wide area networks (WANs), satellite networks, cable networks, Wi-Fi network, WiMax networks, mobile communications networks (e.g. 3G, 4G, and so forth), Bluetooth or near field communication (NFC) networks, or any combination thereof.

FIG. 1B illustrates the authentication system 108 operating independently of the protected resource 104. The authentication system 108 can communicate with the client device(s) 102(1)-102(N) and the protected resource 104 via one or more network(s) 110. In this example, the authentication system 108 receives an access request 120 from one of the client device(s) 102(1)-102(N) via one or more network(s) 110. Once the authentication system 108 verifies the authenticity of the access request 120, the authentication system 108 can transmit an authentication token 130 to the client device(s) 102(1)-102(N). The client device(s) 102(1)-102(N) can then use the authentication token 130 to access the protected resource 104. In some examples, the authentication token 130 may comprise encrypted data, such as an identifier of the protected resource 104, an identifier of the authentication system 108, or an identifier of the client device(s) 102(1)-102(N). The protected resource 104 may authenticate the authentication token 130 by decrypting the token with a cryptographic key, and verifying the corresponding identifier as provided.

Moreover, the authentication system 108 may operate on one or more distributed computing resource(s). The distributed computing resource(s) may include one or more computing device(s) that operate in a cluster or other configuration to share resources, balance load, increase performance, provide fail-over support or redundancy, or for other purposes. The one or more computing device(s) may include one or more interfaces to enable communications with other networked devices, via one or more network(s) 110.

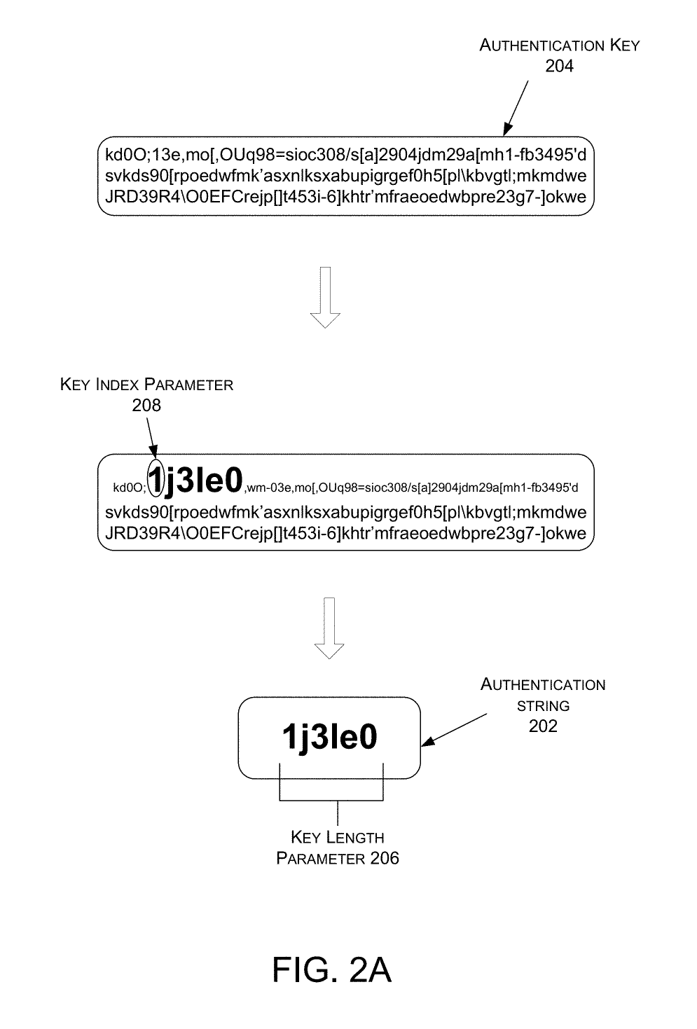

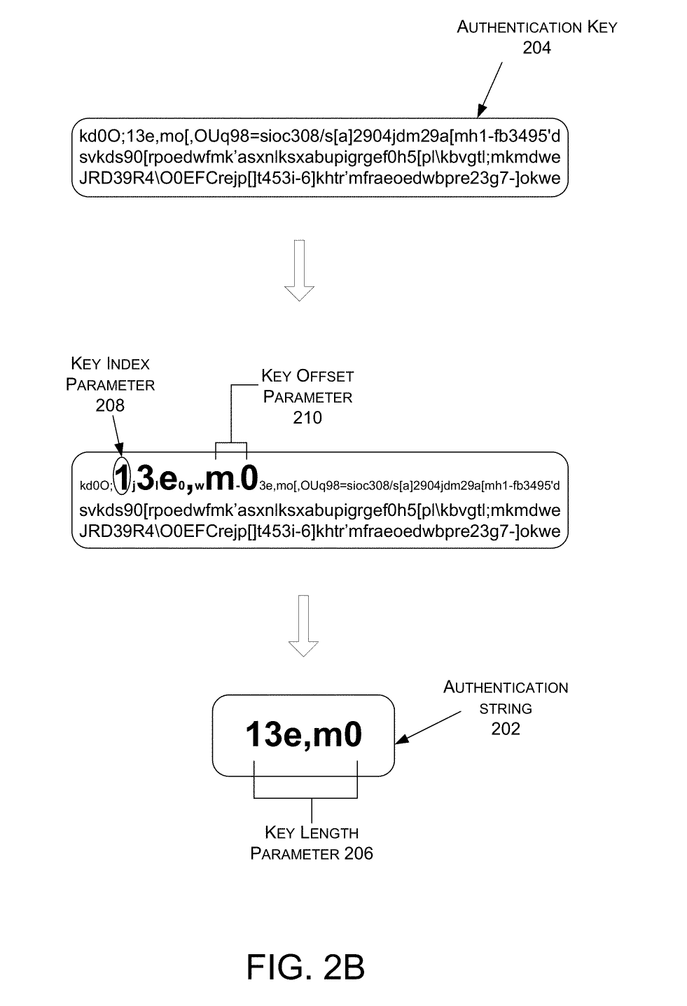

FIGS. 2A and 2B illustrate a use of one or more authentication parameters to derive an authentication string 202 from an authentication key 204. The authentication key 204 can be generated by any method that can produce a long string of random characters. As noted earlier, a “long string” as used herein describes a specific number of characters that define an authentication key that is equal to or exceeds a number of characters associated with an authentication string. The authentication key 204 can be created and used in any format, such as, but not limited to bits, bytes, hexadecimal, ASCII, and Unicode. The length of the authentication key 204 can vary from a few bits, bytes to terabytes, petabytes, and beyond. As a non-limiting example, a four-byte authentication key 204 has four billion potential combinations, making a brute force attempt to trial various authentication string combinations computationally burdensome. In some examples, the authentication system can also instigate a time delay of two or more seconds which can reduce a number of potential attempts to less than 45,000 per day. Further, the length of the authentication key 204 can be based on an architect's security requirements and system capabilities. In some examples, the authentication key 204 can be of a fixed size. In other examples, the authentication key 204 can be of variable length based on the security requirements of the authenticating system.

In various examples, the authentication key 204, comprising machine-readable data, can be generated by an alpha-numeric coding by a mathematical random number/character generator. In other examples, the authentication key 204, comprising machine-readable data, can be generated by an alpha-numeric coding of environmental data, such as, but not limited to, background radiation, background noise from a particular geolocation (i.e. busy street), physical baseband spectrum noise, and sunlight wavelength. In other examples, the authentication key 204 can be generated by coding individual pixels in a particular digital photo, a specific text from a particular publication, or an audio excerpt from particular composition or digital recording. In other words, the authentication key 204 of character can be generated by any means of digitally coding a long string of characters that are unique to a moment in time, an environmental condition, or an individual user. In some examples, the authentication key 204 is derived by a client device and shared with an authentication system. In other examples, the authentication key 204 is derived by the authentication system and shared with the client device. The authentication key 204 can be derived by one or more hardware sensors associated with the client device or the authentication system. The hardware sensors can include, but are not limited to a microphone, global positioning system, optical sensor, and radiation sensor.

In the illustrated example, an authentication string 202 can be derived from the authentication key 204 using one or more authentication parameters. The authentication string 202 is derived by processing the machine-readable data of the authentication key 204 using the one or more authentication parameters. The one or more authentication parameters can include, a key length parameter 206, a key index parameter 208, a key offset parameter 210, and in some cases where more complex and higher security implementations are required, a randomizer parameter 212.

In the illustrated example, the key length parameter 206 can include a numerical value that denotes the number of characters that make up the authentication string 202. For example, a key length parameter 206 of three hundred reflects an authentication string 202 of three hundred characters. The key length parameter 206 can include any numerical value that is equal to or lesser than the character length of an authentication key 204. In some examples, the key length parameter 206 may be determined by the anticipated total number uses of the authentication string 202. For example, consider an authentication string 202 that is to be implemented as part of a vehicle fob key. An architect of the authentication string 202 may determine that a vehicle is accessed approximately eight times a day for twenty years. If an authentication string 202 having a four-byte character length is assigned to the vehicle fob key, an authentication key 204 length of 233,600 bytes (i.e. 4 bytes×8 uses per day×365 days per year×20 years) is required. Current computing technology can adequately facilitate a 233 kb storage requirement. In FIG. 2A, the illustrated key length parameter 206 is six bytes, meaning that the character length of the authentication string 202 is six characters, those being “1j31e0”.

In the illustrated example, the key index parameter 208 identifies a character position within the authentication key 204 that corresponds to a first character of the authentication string 202. In the illustrated example, the key index parameter 208 is six. Therefore, the first character of the authentication string 202 is the sixth character of the authentication key 204.

In various examples, the key index parameter 208 can be used to vary an authentication string 202 after a predetermined period of time. In some examples, a change in the key index parameter 208 can be based on algorithm shared between a client device and the authentication system. As a non-limiting example, consider an authentication string that is to change on a daily basis for a single day authentication. In this example, determining a new authentication string each day can be implemented by modifying the key index parameter 208 by an independent parameter. In one example, the independent parameter can be the current date. For example, a date of Aug. 7, 2015 can coded as a key index parameter 208 of “872015,” meaning that the first character of the authentication string 202 is located at an index position of 872,015 of the authentication key 204. In other examples, the key index parameter 208 can be determined by an integer (i.e. 1 to n), or algorithmically in an index key table shared between a client device and the authentication system. Depending on design needs, the client device or the authentication system can provide the key index parameter 208.

In FIG. 2B, the illustrated example includes a key offset parameter 210. The key offset parameter can include a numerical value that identifies a next character of the authentication string 202 within the authentication key 204. In the illustrated example, the key offset parameter 210 corresponds to “two.” In this example, a subsequent character in an authentication string 202 is identified as being offset by two character positions from the last identified character position within the authentication key 204. Therefore, when combined with a key length parameter 206 and a key index parameter 208, the authentication string in FIG. 2B corresponds to “13e,m0”.

In other examples, the key offset parameter 210 can be determined by a formula that identifies a subsequent character position. As a non-limiting example, consider a key offset formula of “2x” where x is the “hour” of a day during which an access request is received by the authentication system. In this example, the access request received at 9 am can be used to determine a key offset parameter 210 of “18” (i.e. 2×9). In some examples, the key offset parameter 210 can be determined by an integer (i.e. 1 to n), or algorithmically from a key offset parameter 210 index table that is shared between a client device and the authentication system. Depending on design needs, the client device or the authentication system can provide the key offset parameter 210.

In various examples, an additional randomizer parameter can be included. In various examples of high security implementations, a client device can use a randomizer variable or function to shuffle an authentication string 202 prior to sending the authentication string 202 to the authenticating system. In doing so, the authenticating system may re-sequence the authentication string 202 using a complementary randomizer variable or function. In this example, if an authentication process is compromised during a transmission between a client device and the authentication system, then the compromising party still requires the randomizer variable or function in order to discern the authentication string 202.

In various examples, the use of a randomizer variable or function can provide additional security measures to complex and high security implementations, such as those performed by banking institutions. In this example, a request to transfer electronic payments that debit or credit financial resources can be accompanied by a randomizer variable or function. Similarly, a randomizer variable or function can be used in the context of a power grid control sub-station, where generators are placed on or off the grid, and where grid circuit breakers are opened or closed.

In various examples, either one of the client device or the authentication system can change the authentication string 202 at any point in time. A change to the authentication string 202 can be performed by changing any one or more of the authentication parameters. Once the client device or the authentication system has changed an authentication string 202, the client device or the authentication system need only communicate the altered authentication parameters. In doing so, the changed authentication string 202 can be reproduced using the altered authentication parameters, without a need for communicating the altered authentication string itself.

In some examples, the change in the authentication string 202 can also be performed by changing the authentication key 204 itself. In doing so, the client device or the authentication system that instigated the change to the authentication key 204 may communicate the changed authentication key 204 to the other party.

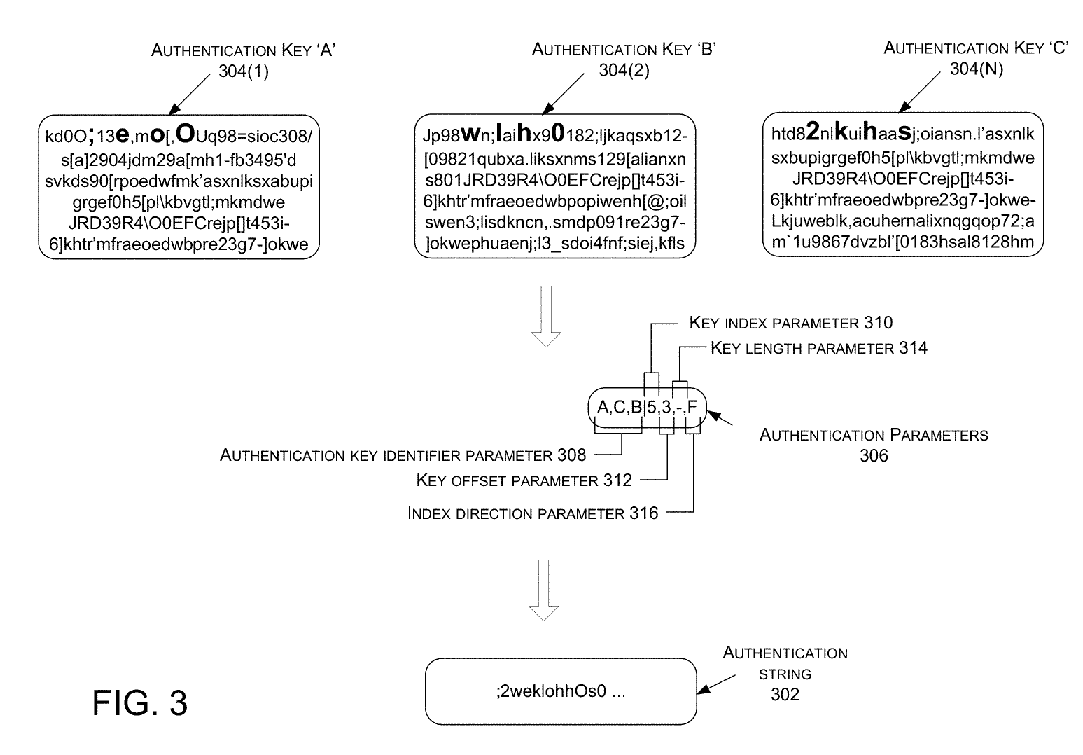

FIG. 3 illustrates a block diagram of a process of deriving an authentication string 302 from a plurality of authentication keys 304(1)-304(N). In the illustrated example, the authentication string 302 is derived from three authentication keys, namely 304(1), 304(2), and 304(N), however one of ordinary skill in the art would appreciate that any number of authentication keys may be used to derive the authentication string 302. The authentication keys 304(1)-304(N) may correspond to authentication key 204 and can be generated by any method that can produce a long string of random characters.

The authentication string 302 may be derived using one or more authentication parameters 306. In the illustrated example, the one or more authentication parameters 306 include an authentication key identifier parameter(s) 308, a key index parameter 310, a key offset parameter 312, a key length parameter 314, and an index direction parameter 316. The key index parameter 310 may correspond to key index parameter 208, the key offset parameter 312 may correspond to key offset parameter 210, and the key length parameter 314 may correspond to key length parameter 206. Moreover, the one or more authentication parameters 306 are presented in a particular order for illustrative purposes only. The one or more authentication parameters 306 may be presented in any order or in any form that is computationally efficient. Further, the authentication key identifier parameter(s) 308 and the key index parameter 310 is separated by a vertical bar character “1” for illustrative purposes only.

In the illustrated example, the authentication key identifier parameter(s) 308 comprises “A, C, B”. In this example, the authentication key identifier parameter 3 identifies authentication key “A”, “B”, and “C.” For illustrative purposes only, the authentication key identifiers are separated by a comma “,” symbol, however any means of separation is possible. Further, the authentication key identifier parameter(s) 308 further identifies a sequential order of authentication keys. For example, based on the authentication key parameter “A, C, B”, a first character may be derived from authentication key “A” 304(1), a second character may be derived from authentication key “C” 304(N), and a third character may be derived from authentication key “B” 304(2).

In the illustrated example, the key index parameter 310 is five. Therefore, the first character of the authentication string 302 from each of the authentication keys 304(1)-304(N) is the fifth character of the authentication keys 304(1)-304(N), respectively.

Moreover, the key offset parameter 312 in the illustrated example is three. Therefore, a next character from each of the authentication keys 304(1)-304(N) is offset by three character-positions from the last identified character position within each of the authentication keys 304(1)-304(N), respectively.

Further, the key length parameter 314 in the illustrated example is “-”, which, for illustrative purposes only, represents an “undefined value.” In some examples, an “undefined value” may indicate that the authentication string 302 is derived based on the entire length of the authentication keys 304(1)-304(N), subject to character selection criteria of the other authentication parameters, such as the key index parameter 310, the key offset parameter 312, and the index direction parameter 318.

Additionally, the index direction parameter 318 in the illustrated example is “F,” which for illustrative purposes only, indicates a forward (i.e. left to right) direction, in contrast to “B,” which would indicate a backward (i.e. right to left) direction. It is noteworthy that any annotation that indicates and distinguishes between a forward (i.e. left to right) direction and backward (i.e. right to left) direction is possible.

Therefore, the authentication string 302 includes a first sequence of characters “;” “2” and “w” derived from authentication keys ‘A’, ‘C’, and ‘B’ respectively, and based on a first character position of define by the key index parameter 310. The second sequence of characters “e” “k” and “l” within the authentication string 302 are derived from the same sequence and order of authentication keys 304(1)-304(N) and are further based on the key index parameter 310 and the index direction parameter 316. The third and subsequent sequences of characters within the authentication string 302 are further based on the key length parameter 314.

FIG. 4 illustrates a block diagram of a process of deriving an authentication string from a plurality of authentication keys. In the illustrated example, the authentication string 402 is derived from three authentication keys, namely 404(1), 404(2), and 404(N), however one of ordinary skill in the art would appreciate that any number of authentication keys may be used to derive the authentication string 402. The authentication keys 404(1)-404(N) may correspond to authentication keys 304(1)-304(N). In the illustrated example, the authentication parameters 406 comprise of an authentication key identifier parameter that identifies authentication keys “A” “C”, and “B.” Further, the authentication parameters further include three discrete sets of an key index parameter, a key offset parameter, a key length parameter, and an index direction parameter, each of which relate to an authentication key identified by the authentication key identifier parameter. The key index parameter corresponds to key index parameter 310, the key offset parameter corresponds to key offset parameter 312, the key length parameter corresponds to key length parameter 314, and the index direction parameter corresponds to index direction parameter 318.

Moreover, the first discrete set of authentication parameters, separated by the vertical bar symbol “|” relate to authentication key “A” 404(1) corresponds to “A, 5, 3, -, F,” the second set of authentication parameters, namely “C, 17, 4, 4, B,” relates to authentication key “C” 404(N), and the third set of authentication parameters, namely “B, 8, 6, -, F,” relates to authentication key ‘B” 404(2), based on the sequential order of the authentication keys within the authentication key identifier parameter. The derivation of the authentication string 402 is further based on the process described in FIG. 3.

In the illustrated example, each character of the authentication string sequentially iterates from authentication key “A” 404(1), through to authentication key “C” 404(N), and then through to authentication “B” 404(2). According to authentication parameters 406, the index parameter associated with authentication key “A” 404(1) is give, the key offset parameter is three, the key length parameter is undefined, and index direction parameter is forward (i.e. left to right). Regarding authentication key “C” 404(N), the index parameter is 17, the key offset parameter is four, the key length parameter is four, and the index direction parameter is backward (i.e. right to left). It is noteworthy that since the key length parameter of authentication key “A” 404(1) is greater than the key length parameter of authentication key “C” 404(N), as soon as four characters from authentication key “B” 404(N) are transcribed within the authentication string 402, the remaining characters of the authentication string 402 are defined by the authentication keys with key length parameters greater than four (i.e. key length parameter of authentication key “C” 404(N)), namely authentication key “A” 404(1) and authentication key “B” 404(2).

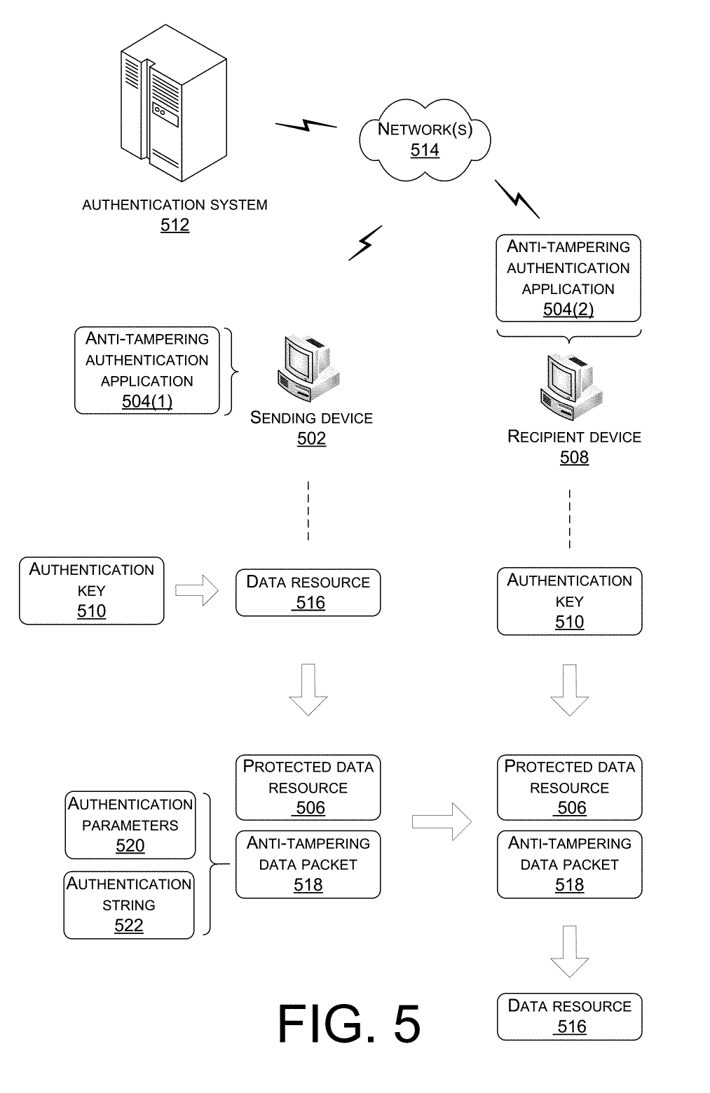

FIG. 5 illustrates a block diagram of a first example of a sending device 502 using an anti-tampering authentication application 504(1) to transmit a protected data resource 506 from to a recipient device 508. In the illustrated example, an authentication key 510 is shared with the recipient device 508. The authentication key 510 may have been shared by either one of the sending device 502 or the recipient device 508 via previous interactions.

In other examples, the authentication key 510 may have been transmitted to the sending device 502 and the recipient device 508 via an authentication system 512 that resides on a remote server. The authentication system 512 may correspond to authentication system 108. Further, the authentication key 510 may reside on the sending device 502 and the recipient device 508, respectively. In other examples, the authentication key 510 may reside on an authentication system 512 that is accessible by the sending device 502 and the recipient device 508 via one or more network(s) 514. It is noteworthy that even though this example describes the sending device 502 and the recipient device 508 sharing authentication key 510, the sending device 502 and the recipient device 508 may share multiple authentication keys. In this way, the combination of multiple authentication keys may be used to derive an authentication string, as described earlier with reference to FIGS. 3 and 4.

In the illustrated example, the anti-tampering authentication application 504(1) that resides on the sending device 502 may generate a protected data resource 506 by mathematically coupling the authentication key 510 with a data resource 516 that is intended for delivery to the recipient device 508. The data resource 516 may include one of a data file, multimedia file, application file, or any other type of data packet that can be transferred between a sending device and recipient device, via one or more network(s) 514. In this instance, the protected data resource 506 is inaccessibly by any client device until first uncoupled from the authentication key 510.

Further, the anti-tampering authentication application 504(1) may generate an anti-tampering data packet 518 that includes, one or more authentication parameter(s) 520, an authentication string 522, and computational instructions that automatically decouple the protected data resource 506 from the authentication key 510 in response to a successful authentication of the authentication string 522. The one or more authentication parameter(s) 520 may be used in combination with the authentication key 510 to derive the authentication string 522. The one or more authentication parameter(s) 520 may include, but are not limited to, a key index parameter, a key offset parameter, a key length parameter, and an index direction parameter.

Moreover, the sending device 502 may transmit the protected data resource 506 and the anti-tampering data packet 518 to the recipient device 508. In doing so, the anti-tampering authentication application 504(2) that resides on the recipient device 508 may derive an authentication string based on the one or more authentication parameter(s) 520 of the anti-tampering data packet 518 and the authentication key 510 that is accessible on the recipient device 508. Further, the anti-tampering authentication application 504(2) may compare the derived authentication string with the authentication string 522 of the anti-tampering data packet 518. In response to determining that the derived authentication string matches the authentication string 522 are substantially similar, the anti-tampering authentication application 504(2) may execute the computational instructions that automatically decouple the protected data resource 506 from the authentication key 510. In doing so, the data resource 516 may be accessible on the recipient device 508. The anti-tampering authentication system The term “substantially similar” as used herein may describe a quantitative similarity between authentication strings that corresponds to an exact match, or that is defined by a Euclidean or vector cosine distance.

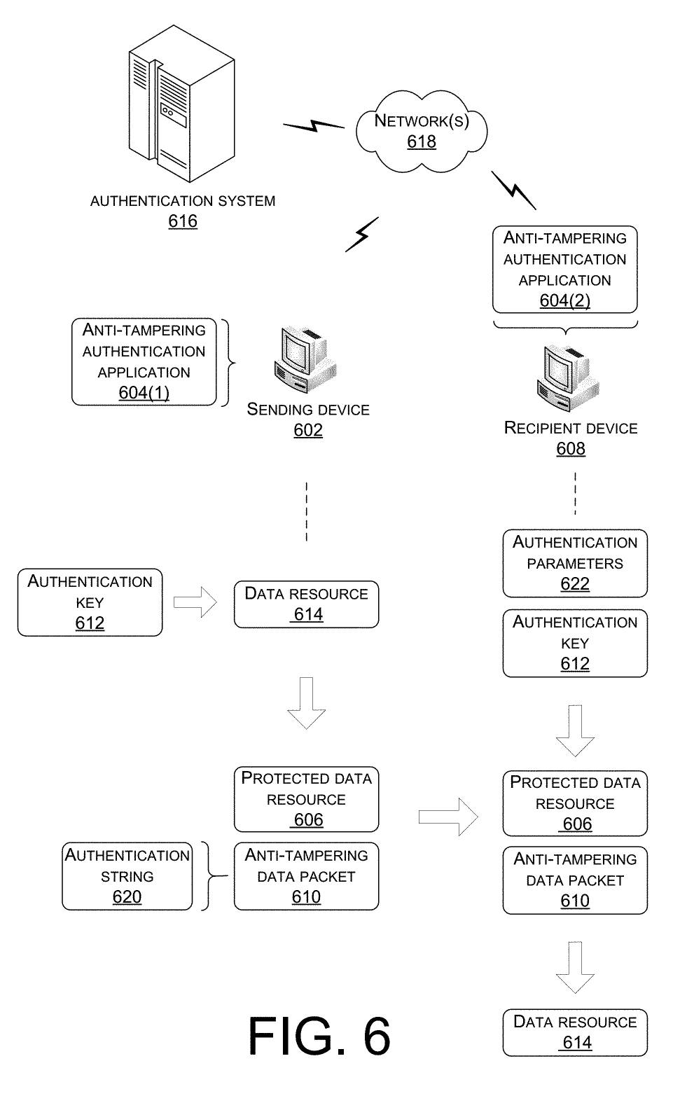

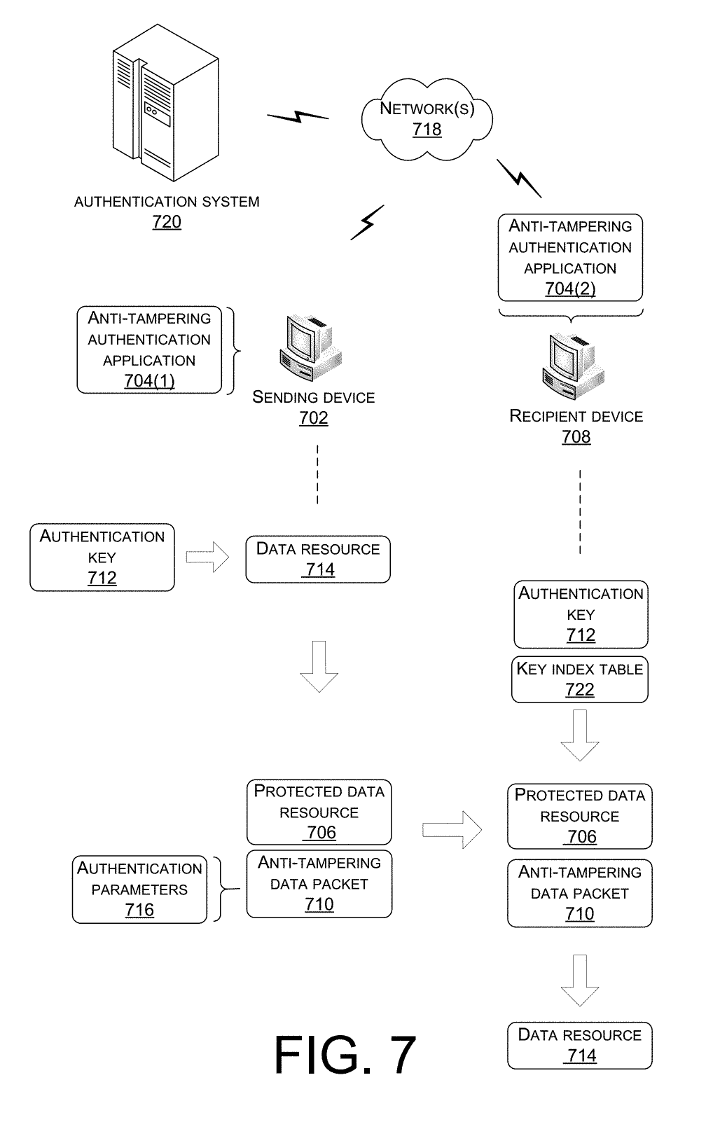

It is noteworthy that the anti-tampering data packet 518 may include any combination or permutation of one or more authentication parameter(s) 520, authentication string 522, and authentication key 510. FIGS. 6 and 7 provide two additional non-limiting examples of different combinations of authentication data included within the anti-tampering data packet 518.

In the illustrated example, the one or more network(s) 514 may correspond to the one or more network(s) 110, and can include public networks such as the Internet, private networks such as an institutional and/or personal intranet, or some combination of private and public networks. The one or more network(s) 514 can also include any type of wired and/or wireless network, including but not limited to local area network (LANs), wide area networks (WANs), satellite networks, cable networks, Wi-Fi network, WiMax networks, mobile communications networks (e.g. 3G, 4G, and so forth), Bluetooth or near field communication (NFC) networks, or any combination thereof

Further, the sending device 502 and the recipient device 508 may correspond to client device(s) 102(1)-102(N), and include any one of a laptop computer, tablet computer, cellular phone, or any other electronic device that can send and receiving data via one or more network(s) 514.

FIG. 6 illustrates a block diagram of a second example of a sending device 602 using an anti-tampering authentication application 604(1) to transmit a protected data resource 606 to a recipient device 608. The second example presented in FIG. 6 substantially corresponds to the first example of FIG. 5 but for the composition of the anti-tampering data packet 610, as discussed in further detail below. In this example, the anti-tampering authentication application 604(1) that resides on the sending device 602 may generate a protected data resource 606 by mathematically coupling an authentication key 612 with a data resource 614 that is intended for delivery to the recipient device 608. In some examples, the authentication key 612 may reside on the sending device 602. In other examples, the authentication key 612 may reside on an authentication system 616 that is accessible by the sending device 602 and recipient device 608, via one or more network(s) 618.

Further, the anti-tampering authentication application 604(1) may generate an anti-tampering data packet 610 that includes an authentication string and computational instructions that automatically decouple the protected data resource 606 from the authentication key 612 in response to a successful authentication of the authentication string 620.

Moreover, the sending device 602 may transmit the protected data resource 606 and the anti-tampering data packet 610 to the recipient device 608, via the one or more network(s) 618. In doing so, the anti-tampering authentication application 604(2) that resides on the recipient device 608 may derive an authentication string based on one or more authentication parameters 622 and an authentication key 612 that reside on the recipient device 608. Further, the anti-tampering authentication application 604(2) may compare the derived authentication string with the authentication string 620 of the anti-tampering data packet 610. In response to determining that the derived authentication string and the authentication string 620 are substantially similar, the anti-tampering authentication application 604(2) may execute the computational instructions that automatically decouple the protected data resource 606 from the authentication key 612. In doing so, the data resource 614 may be accessible on the recipient device 608.

FIG. 7 illustrates a block diagram of a third example of a sending device 702 using an anti-tampering authentication application 704(1) to transmit a protected data resource 706 to a recipient device 708. The third example presented in FIG. 7 substantially corresponds to the first example of FIG. 5 and the second example of FIG. 6 but for the composition of the anti-tampering data packet 710, as discussed in further detail below. In this example, the anti-tampering authentication application 704(1) that resides on the sending device 702 may generate a protected data resource 706 by mathematically coupling an authentication key 712 with a data resource 714 that is intended for delivery to the recipient device 708. Further, the anti-tampering authentication application 704(1) may generate an anti-tampering data packet 710 that includes one or more authentication parameters 716 and computational instructions that automatically decouple the protected data resource 706 from the authentication key 712 in response to a successful authentication of an authentication string.

Moreover, the sending device 702 may transmit the protected data resource 706 and the anti-tampering data packet 710 to the recipient device 708, via one or more network(s) 718. In doing so, the anti-tampering authentication application 704(2) that resides on the recipient device 708 may derive an authentication string based on one or more authentication parameters 716 from the anti-tampering data packet 710 and an authentication key 712. In some examples, the authentication key 712 may reside on the recipient device 708. In other examples, the authentication key 712 may reside on an authentication system 720 that is accessible by the recipient device 708, via the one or more network(s) 718.

Further, the anti-tampering authentication application 704(2) may compare the derived authentication string with an authentication string stored within a key index table 722 on the recipient device 708. The key index table 722 may correlate a sending device identifier associated with the sending device 702 with an authentication string. In response to determining that the derived authentication string is substantially similar to an authentication string stored within the key index table 722, the anti-tampering authentication application 704(2) may execute the computational instructions that automatically decouple the protected data resource 706 from the authentication key 712. In doing so, the data resource 714 may be accessible on the recipient device 708.

FIG. 8 illustrates a block diagram of various components of an authentication system 802. The authentication system 802 may include routines, program instructions, objects, and/or data structures that perform particular tasks or implement abstract data types. Further, the authentication system 802 may include input/output interface(s) 804. The input/output interface(s) 804 may include any type of output interface known in the art, such as a display (e.g. a liquid crystal display), speakers, a vibrating mechanism, or a tactile feedback mechanism. Input/output interface(s) 804 also include ports for one or more peripheral devices, such as headphones, peripheral speakers, or a peripheral display. Further, the input/output interface(s) 804 may further include a camera, a microphone, a keyboard/keypad, or a touch-sensitive display. A keyboard/keypad may be a push button numerical dialing pad (such as on a typical telecommunication device), a multi-key keyboard (such as a conventional QWERTY keyboard), or one or more other types of keys or buttons, and may also include a joystick-like controller and/or designated navigation buttons, or the like.

Additionally, the authentication system 802 may include network interface(s) 806. The network interface(s) 806 may include any sort of transceiver known in the art. For example, the network interface(s) 806 may include a radio transceiver that performs the function of transmitting and receiving radio frequency communications via an antenna. In addition, the network interface(s) 806 may also include a wireless communication transceiver and a near field antenna for communicating over unlicensed wireless Internet Protocol (IP) networks, such as local wireless data networks and personal area networks (e.g. Bluetooth or near field communication (NFC) networks). Further, the network interface(s) 806 may include wired communication components, such as an Ethernet port or a Universal Serial Bus (USB).

Further, the authentication system 802 may include one or more processor(s) 808 that are operably connected to memory 810. In at least one example, the one or more processor(s) 808 may be a central processing unit(s) (CPU), graphics processing unit(s) (GPU), a both a CPU and GPU, or any other sort of processing unit(s). Each of the one or more processor(s) 808 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution. The one or more processor(s) 808 may also be responsible for executing all computer applications stored in the memory, which can be associated with common types of volatile (RAM) and/or nonvolatile (ROM) memory.

In some examples, memory 810 may include system memory, which may be volatile (such as RAM), non-volatile (such as ROM, flash memory, etc.) or some combination of the two. The memory may also include additional data storage devices (removable ad/or non-removable) such as, for example, magnetic disks, optical disks, or tape.

The memory 810 may further include non-transitory computer-readable media, such as volatile and nonvolatile, removable and non-removable media implemented in any method or technology for storage of information, such as computer readable instructions, data structures, program modules, or other data. System memory, removable storage and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

In the illustrated example, the memory 810 may include an operating system 812, an authentication key storage module 814, an authentication parameters module 816, a key index module 818, and an authentication string processing module 820. The operating system 812 may be any operating system capable of managing computer hardware and software resources.

In various examples, the authentication key storage module 814 can store authentication keys that correspond to a plurality of client devices. Each authentication key can be identified by a client device identifier. In some examples, in response to receiving an access request from a client device, the authentication system 802 can use the client device identifier that accompanies the access request to identify the authentication key that is associated with the client device.

In various examples, the authentication system 802 can authenticate an access request by sending a client device, one or more authentication parameters and requesting an authentication string in return. The one or more authentication parameters can be stored within an authentication parameters module 816 within the authentication system 802. The authentication parameters module 816 can store authentication parameters such as, a key index parameter, a key offset parameter, a key length parameter, and a randomizer variable or function. In this example, the authentication system 802 may process a returned authentication string to determine whether to grant the client device access to the protected resource. Since the authentication system 802 and the client device share the same authentication key, the authentication system 802 need only provide the client device with the one or more authentication parameters from the authentication parameters module 816. An advantage of this type of authentication process is that the authentication system 802 can change an authentication string at any time without requiring interaction with the client device.

In various examples, authentication of an access request can be performed using a key index module 818. The key index module 818 can store a key index table that associates one or more authentication strings to a protected resource. The key index table can also associate a particular type of access to the protected resource. In the illustrated example in FIG. 8, the authentication string “12q0jrfdh” is associated with Vehicle B (i.e. protected resource), and provides a type of access that corresponds to “start engine.” FIG. 8 also illustrates another example, in which a different authentication string “20djh4h5” is associated with the same Vehicle B, however access is limited to only “Open Doors.” In a non-limiting example, the authentication system can verify the authentication string associated with an access request, and then using the key index table, identify the relevant protected resource and the associated type of access that is permitted.

In various examples, the authentication string processing module 820 can derive an authentication string using an authentication key and one or more authentication parameters. In some examples, the authentication string processing module 820 can compare the derived authentication string to an authentication string received with an access request. In some examples, the authentication string processing module 820 can compare a derived authentication string to authentication strings stored within the key index module 818. In other examples, the authentication string processing module 820 can perform a combination of comparing a derived authentication string to an authentication string that accompanies an access request, and an authentication string that is stored within the key index module 818.

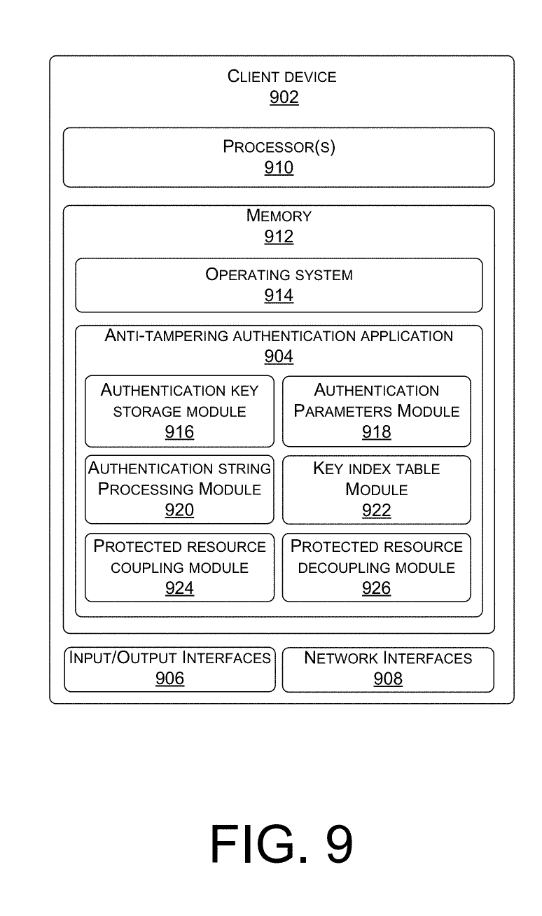

FIG. 9 illustrates an example architecture of a client device 902 that is configured to execute an anti-tampering authentication application 904. In one example, the client device 902 may generate a protected data resource for delivery to a recipient, client device. In this example, the anti-tampering authentication application 904 may be configured to generate the protected data resource by mathematically combining an authentication key with a data resource. In this way, the protected data resource may be inaccessible by any client device until the authentication key is first decoupled from the protected data resource.

In another example, the client device 902 may receive a protected data resource from a sending, client device. In this example, the anti-tampering authentication application 904 that resides on the client device 902 may be configured to verify an authenticity of an authentication string associated with the protected data resource, and in doing so, mathematically de-couple the authentication key from the data resource. In this way, the data resource may be accessible via the client device 902.

It is noteworthy that the operations and processes described below as being performed by the anti-tampering authentication application 904 may be performed by the authentication system 108 in the alternative, and further communicated to the anti-tampering authentication application 904, via the one or more network(s) 110.

In the illustrated example, the client device 902 may correspond to client device(s) 102(1)-102(N). Particularly, client device 902 may be communicatively coupled to the authentication system 108, and other client devices, via one or more network(s) 110.

Further, the client device may include input/output interface(s) 906 and network interface(s) 908. The input/output interface(s) 906 may correspond to input/output interface(s) 804 and the network interface(s) 908 may correspond to network interface(s) 806.

In the illustrated example, the client device 902 may include one or more processor(s) 910 operably connected to memory 912. The one or more processor(s) 910 may correspond to the one or more processor(s) 808, and the memory 912 may correspond to memory 810.

Moreover, the memory 912 may include an operating system 914, and the anti-tampering authentication application 904. The operating system 914 may be any operating system capable of managing computer hardware and software resources. Further, the anti-tampering authentication application 904 may include an authentication key storage module 916, an authentication parameters module 918, an authentication string processing module 920, key index table module 922, a protected resource coupling module 924, and a protected resource decoupling module 926.

In the illustrated example, the authentication key storage module 916 may correspond to the authentication key storage module 814, the authentication parameters module 918 may correspond to the authentication parameters module 816, and the key index table module 922 may correspond to the key index module 818. Further, the protected resource coupling module 924 may be configured to mathematically combine an authentication key with a data resource. In this way, the protected data resource may be inaccessibly by any client device until the authentication key is first decoupled from the protected data resource. Further the protected resource coupling module 924 may generate computational instructions that automatically decouple the protected data resource from the authentication key in response to a successful authentication of an authentication string at a recipient, client device.

Moreover, the protected resource decoupling module 926 may be configured to execute computational instructions that automatically decouple a protected data resource from an authentication key in response to a successful authentication of an authentication string.

FIG. 10 illustrates an example flow of an authentication system that grants access to a protected resource in response to receiving an access request from a client device that includes a client device identifier, a first authentication string, one or more authentication parameters, and a particular type of access request.

At 1002, the authentication system receives the access request from the client device. The access request can include a client device identifier, a first authentication string, one or more authentication parameters, and a request for a particular type of access. In this example, the authentication system can use the one or more authentication parameters from the access request to derive and validate the first authentication string provided with the access request. Further, the particular type of access may include a temporal restriction on access to the protected resource or a functional restriction on access to the protected resource. In a non-limiting example, the request for a particular type of access may involve commercial building access during working hours. In another non-limiting example, the particular type of access may involve accessing balance information of a financial resource, or performing a financial transaction using a financial resource. In other examples, the access request for a particular type of access may include unrestricted access to the protected resource.

At 1004, the authentication system identifies a shared authentication key that corresponds to the client device identifier. In various examples, an authentication system may store authentication keys associated with several, if not millions, of client devices. Thus, a client identifier can efficiently identify a particular authentication key that is associated with a particular client device. Note that a same client device may share multiple authentication keys with an authentication system. Thus, by extension, a same client device may have multiple client device identifiers, because each authentication key associates a particular client device with a particular protected resource. If a client device accesses multiple protected resources, then each protected resource will likely have its own unique authentication key. Thus, the authentication system uses the client device identifier to identify a particular shared authentication key for a particular protected resource.

At 1006, the authentication system derives a second authentication string using the identified authentication key, and the one or more authentication parameters provided with the access request. The one or more authentication parameters may include a key index parameter, a key offset parameter, a key length parameter, or a randomizer variable or function.

At 1008, the authentication system compares the first authentication string received with the access request to the second authentication string derived by the authentication system.

At 1010, in response to the authentication system verifying that the first authentication string matches the second authentication string, the authentication system can grant the client device access to the protected resource based at least in part on particular type of access included in the access request. In some examples, the authentication system may be an integrated part of the protected resource. Thus, the authentication system may simply grant the client device access to the protected resource. In other examples, the authentication system may operate independent of the protected resource. Here, the authentication system may provide the client device with a digital token that corresponds to the particular type of access identified in the access request.

At 1012, if however, the authentication system determines that the first authentication string provided with the access request does not match the second authentication string that is derived by the authentication system, the authentication system can transmit an indication to the client device indicating that access to the protected resource is denied.

FIG. 11 illustrates an example flow of an authentication system that grants access to a protected resource in response to receiving an access request from a client device that includes a client device identifier and one or more authentication parameters. FIG. 6 further describes determining access privileges using a key index table.

At 1102, the authentication system receives an access request from a client device. The access request can include a client device identifier and one or more authentication parameters. In this example, the authentication system can use the client device identifier to identify an authentication key that is shared between the client device and the authentication system. Further, the one or more authentication parameters can be used to derive and validate an authentication string when used in combination with an authentication key. The one or more authentication parameters may include a key index parameter, a key offset parameter, a key length parameter, an index direction parameter, an authentication key identifier parameter, or a randomizer variable or a randomizer function.

At 1104, the authentication system can identify an authentication key that corresponds to the client device identifier. In some cases, a same client device may have multiple client device identifiers, because the client device may request access to multiple protected resources. In these cases, each protected resource will likely have its own unique authentication key. Thus, the authentication system uses the client device identifier to identify a particular shared authentication key for a particular protected resource.

At 1106, the authentication system derives an authentication string using the identified authentication key and the one or more authentication parameters. The one or more authentication parameters may include a key index parameter, a key offset parameter, a key length parameter, or a randomizer variable or function.

At 1108, the authentication system compares the derived authentication string with an authentication string that is stored within key index table of the authentication system. The key index table can be used to correlate derived authentication strings with access privileges associated with a protected resource. In various examples, the key index table can associate one or more authentication strings with a protected resource. The key index table can also associate a particular type of access to the protected resource. As a non-limiting example, as illustrated in FIG. 3, the authentication string “23|e<sdh” is associated with Building C (i.e. protected resource), and provides access that corresponds to “common area access only.” In another example, a different authentication string “904-hjf03” is associated with the same Building C, however access is restricted to “8 am-9 am front door access.”

At 1110, in response to the authentication system verifying that the derived authentication string matches an authentication string within the key index table, the authentication system can grant the client device based on the type of access identified in the key index table. In some examples, the authentication system may be an integrated part of the protected resource. Thus, the authentication system may simply grant the client device access to the protected resource. In other examples, the authentication system may operate independent of the protected resource. Here, the authentication system may provide the client device with a digital token that corresponds to the particular type of access identified in the key index table.

At 1112, if however, the authentication system determines that the derived authentication string does not match an authentication string listed in the key index table, the authentication system can transmit an indication to the client device indicating that access to the protected resource is denied.

FIG. 12 illustrates an example flow of an authentication system that grants access to a protected resource in response to receiving an access request from a client device that includes a client device, and a particular type of access request.

At 1202, the authentication system receives the access request from the client device. The access request can include a client device identifier and a request for a particular type of access. In a non-limiting example, the request for a particular type of access may include restricted access to the protected resource. For example, the particular type of access may include being able to unlock a vehicle, but not start the vehicle engine. In another non-limiting example, the request for a particular type of access may include unrestricted access to the protected resource.

At 1204, the authentication system identifies a shared authentication key that corresponds to the client device identifier. In some examples, a same client device may have multiple client device identifiers, because the client device may request access to multiple protected resources. In these examples, each protected resource will likely have its own unique authentication key. Thus, the authentication system may use the client device identifier to identify a particular shared authentication key for a particular protected resource.

At 1206, the authentication system can generate a first authentication string using the identified authentication key and one or more stored authentication parameters. The one or more authentication parameters may include a key index parameter, a key offset parameter, a key length parameter, or a randomizer variable or function.

At 1208, the authentication system can transmit an indication to a client device, requesting a second authentication string. The request can include the one or more stored authentication parameters used by the authentication system to generate the first authentication string. An advantage of this type of authentication process is that the authentication system can change an authentication string at any time without requiring interaction with the client device. For example, to change an authentication string, the authentication system can transmit different authentication parameters to the client device and request an authentication string that corresponds to the different authentication parameters.

At 1210, the authentication system receives a second authentication string from the client device and compares the first authentication string derived by the authentication system with the second authentication string received from the client device.

At 1212, in response to the authentication system verifying that the first authentication string matches the second authentication string, the authentication system can grant the client device access to the protected resource based at least in part on the particular type of access included in the access request. In some examples, the authentication system may be an integrated part of the protected resource. Thus, the authentication system may simply grant the client device access to the protected resource. In other examples, the authentication system may operate independent of the protected resource. Here, the authentication system may provide the client device with a digital token that corresponds to the particular type of access identified in the access request.

At 1214, if however, the authentication system determines that the first authentication string derived by the authentication system does not match the second authentication string received from the client device, the authentication system can transmit an indication to the client device indicating that access to the protected resource is denied.

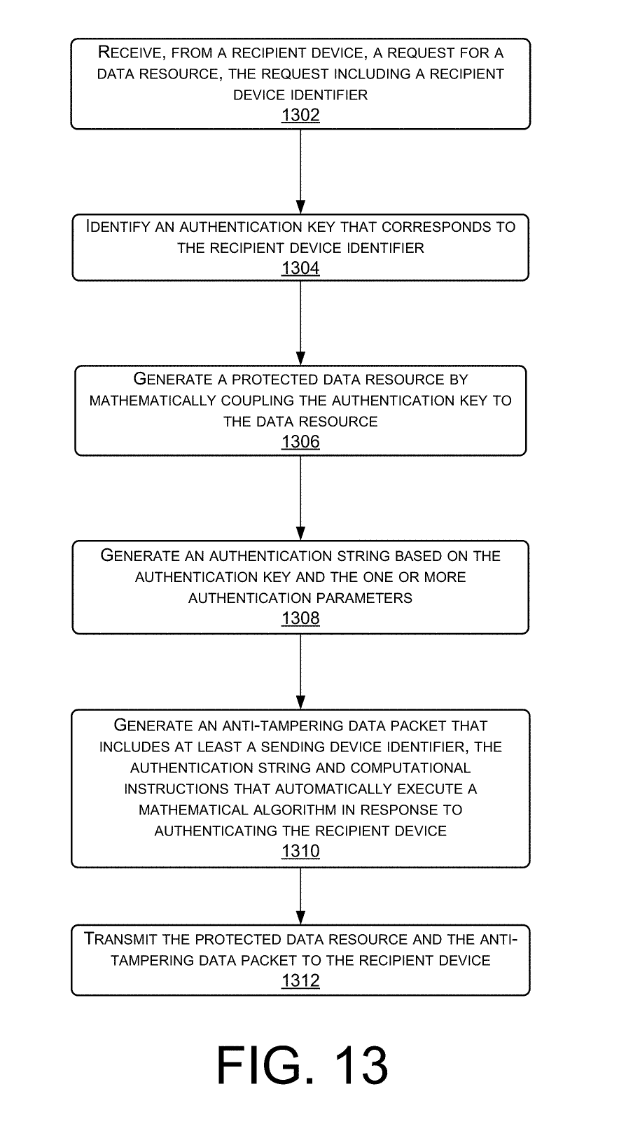

FIG. 13 illustrates an example flow of an anti-tampering authentication application that generates a protected data resource that is intended for delivery to a recipient device. In some examples, the anti-tampering system may reside on a remote server independent of the sending device and recipient device. In other examples, the anti-tampering authentication application may reside on the sending device and recipient device.

At 1302, the anti-tampering authentication application may receive, from a recipient device, a request to access a data resource via the recipient device. In this example, the anti-tampering authentication application may reside on the sending device, or a remote service that is independent of the sending device. Further, the request may further include a recipient device identifier associated with the recipient device,

At 1304, the anti-tampering authentication application may identify an authentication key that corresponds to the recipient device identifier. In one non-limiting example, the authentication key may be an authentication key that has already been shared with the recipient device. In another non-limiting example, the authentication key may be an authentication key that will be prospectively shared with the recipient device.

At 1306, the anti-tampering authentication application may generate a protected data resource by mathematically coupling the authentication key with the data resource. In this instance, the protected data resource is inaccessible by any client device unless first decoupled from the authentication key.

At 1308, the anti-tampering authentication application may generate an authentication string based on the authentication key and one or more authentication parameters. In various examples, the one or more authentication parameters may include a key index parameter, a key offset parameter, or a key length parameter.

At 1310, the anti-tampering authentication application may generate an anti-tampering data packet that includes at least the protected resource, an authentication string associated with the authentication key and computational instructions that automatically execute a mathematical algorithm in response to authenticating the recipient device.

At 1312, the anti-tampering authentication application may transmit the anti-tampering data packet to the recipient device. In some examples, the anti-tampering authentication application may separately transmit one or more authentication parameters to the recipient device for deriving the authentication string using the authentication key that resides on the recipient device.

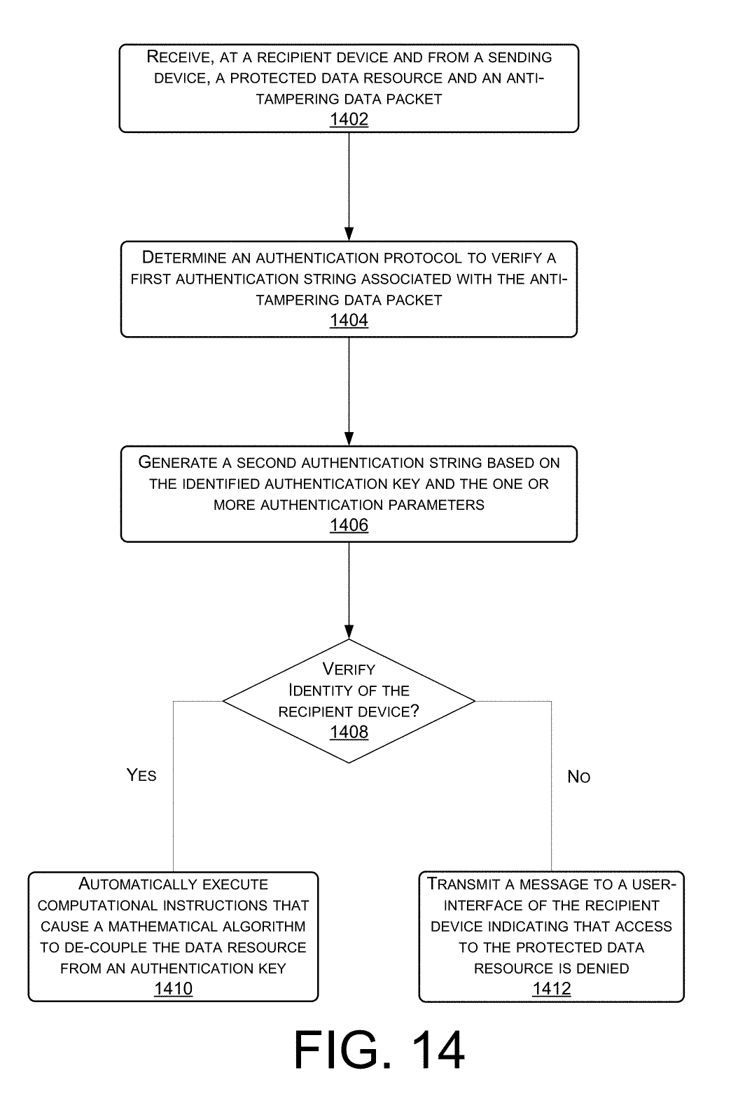

FIG. 14 illustrates an example flow of an anti-tampering authentication application that mathematically decouples the data resource from the authentication based on successfully validating an authentication string using the authentication key.

At 1402, a recipient device may receive from a sending device, a sending device identifier, a protected data resource, and an anti-tampering data packet. The protected data resource may comprise of a data resource that is mathematically coupled to an authentication key. Further, the anti-tampering data packet may include at least an authentication string and computational instructions that automatically decouple the authentication key from the protected data resource.

At 1404, the recipient device may determine an authentication protocol to verify the authentication string associated with anti-tampering data packet, based at least in part on the sending device identifier. In various examples, the authentication protocol may include accessing an authentication key that resides on the recipient device, and one or more authentication parameters that were separately transmitted to the recipient device, by the sending device. Alternatively, the authentication protocol may include accessing an algorithm shared between the recipient device and the sending device that determines the one or more authentication parameters based on numerically quantifiable environmental factors, such as date, time, temperature, humidity at a geographic location, or stock market indices.

At 1406, the recipient device may generate a second authentication string based on the authentication key and the one or more authentication parameters.

At 1408, the recipient device may verify that the second authentication string is substantially similar to the first authentication string associated with the anti-tampering data packet. In some instances, the recipient device may transmit an indication to an anti-tampering authentication application that resides on a remote server that indicates that the first authentication string and the second authentication string are substantially similar.

At 1410, the recipient device may automatically execute computational instructions that cause a mathematical algorithm to de-couple the authentication key from the protected data resource. In doing so, the data resource may be accessible on the recipient device. In some examples, the recipient device may receive the computational instructions the de-couple the authentication key from the protected data resource from an anti-tampering authentication application that resides on a remote server, in response to the anti-tampering authentication application verifying that the first authentication string and second authentication string are substantially similar.

At 1412, the recipient device may display a message on a user-interface of the recipient device that indicates that the recipient device is denied access to the data resource, based at least in part on an ability to verify the authentication string associated with the protected data resource.

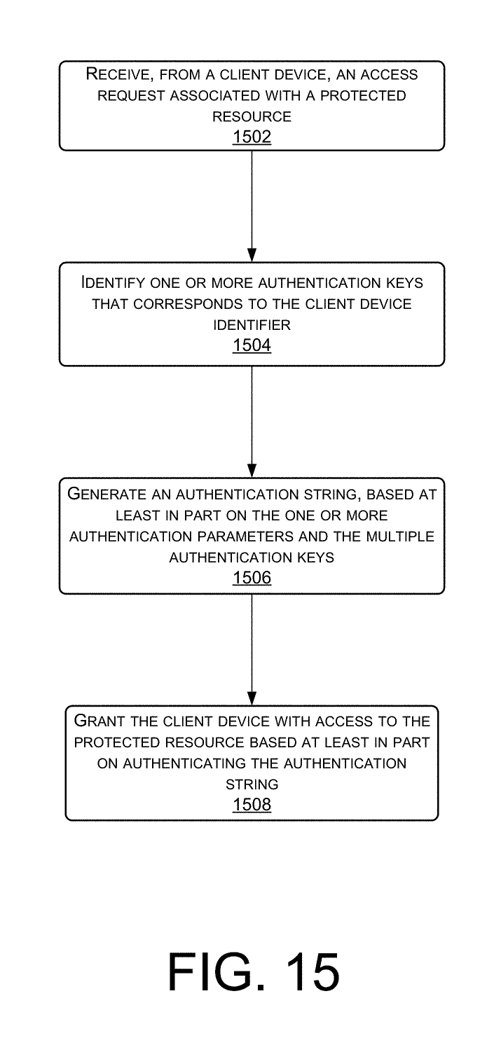

FIG. 15 illustrates an example flow of an authentication system that grants access to a protected resource to response to deriving an authentication string from multiple authentication keys. In one example, the multiple authentication keys may reside within the authentication system.

At 1502, the authentication system may receive, from a client device, an access request for a protected resource. In one example, the access request may include a device identifier, a first authentication string, one or more authentication parameters, and a particular type of access request. In this example, the authentication system can use the client device identifier to identify the multiple authentication keys that are to be used to derive the authentication string. In this example, the multiple authentication keys are shared between the client device and the authentication system via a previous interaction. Further, the one or more authentication parameters can be used to derive and validate an authentication string when used in combination with the multiple authentication keys.

At 1504, the authentication system may identify the multiple authentication keys that correspond to the client device identifier. In some examples, a same client device may have multiple client device identifiers, because the client device may request access to multiple protected resources. In these examples, each protected resource will likely have its own unique combination of multiple authentication keys. Thus, the authentication system may use the client device identifier to identify the particular combination of multiple authentication keys.

At 1506, the authentication system may derive an authentication string using the multiple authentication keys, and the one or more authentication parameters provided with the access request. The one or more authentication parameters may include a key index parameter, a key offset parameter, a key length parameter, an index direction parameter, an authentication key identifier parameter, or a randomizer variable or a randomizer function.

At 1508, the authentication system may grant the client device with access to the protected resource based at least in part on authenticating the authentication string. The authentication system may compare the authentication string derived using the multiple authentication keys, with an authentication string received with the request or stored within the authentication system.

### CONCLUSION

Although the subject matter has been described in language specific to structural features and/or methodological acts, it is to be understood that the subject matter defined in the appended claims is not necessarily limited to the specific features or acts described herein. Rather, the specific features and acts are disclosed as illustrative forms of implementing the claims.

What is claimed:

1. A computer-implemented method, comprising:
under control of one or more processors:
transmitting, from a recipient device to a sending device, a request to access a data resource associated with the sending device;
receiving, at the recipient device, a protected data resource and an anti-tampering data packet, the protected data resource corresponding to a mathematical combination of an authentication key and the data resource, the anti-tampering data packet including at least one or more authentication parameters and a first authentication string;
identifying the authentication key associated with the protected data resource;
determining, a second authentication string based at least in part on the authentication key and the one or more authentication parameters;
verifying that the second authentication string matches the first authentication string; and
granting the recipient device with access to the data resource.

2. The computer-implemented method of claim 1, wherein the request further includes a recipient device identifier associated with the recipient device, and
wherein, to identify the authentication key is further based at least in part on the recipient device identifier.

3. The computer-implemented method of claim 1, wherein the anti-tampering data packet further includes a set of computational instructions that automatically decouple the protected data resource from the authentication key in response verifying the first authentication string associated with the authentication key, based at least in part on the authentication parameters, and
wherein granting the recipient device with access to the data resource further includes automatically executing the set of computational instructions.

4. The computer-implemented method of claim 1, further comprising:
receiving, from the sending device, the authentication key at a point in time prior to transmitting the request to access the data resource.

5. The computer-implemented method of claim 1, further comprising:
transmitting to the sending device, the authentication key at a point in time prior transmitting the request to access the data resource, the authentication key comprising an alpha-numeric coding of at least one of individual pixels in a particular digital photo, a section of text from a particular publication, or an audio excerpt from a particular digital recording.

6. The computer-implemented method of claim 1, wherein the one or more authentication parameters include at least a key index parameter, the key index parameter being a numerical value that identifies a character position within the authentication key that corresponds to a first character of the second authentication string.

7. The computer-implemented method of claim 1, wherein the one or more authentication parameters include a key offset parameter, the key offset parameter corresponding to a numerical value that identifies an offset from a current character position within the authentication key to a next character position within the authentication key, a character at the next character position corresponding to a next character of the first authentication string.

8. One or more non-transitory computer-readable media storing computer-executable instructions that, when executed on one or more processors, cause the one or more processors to perform acts comprising:
transmitting, from a recipient device to a sending device, a request to access a data resource associated with the sending device;
receiving, at the recipient device, a protected data resource and an anti-tampering data packet, the protected data resource corresponding to a mathematical combination of an authentication key and the data resource, the anti-tampering data packet including at least one or more authentication parameters;
identifying the authentication key associated with the protected data resource;
determining, a second authentication string based at least in part on the authentication key and the one or more authentication parameters; and
verifying that the second authentication string matches a first authentication string associated with the data resource; and
granting the recipient device with access to the data resource.

9. The one or more non-transitory computer-readable media of claim 8, further storing instructions that when executed cause the one or more processors to perform acts comprising:
retrieving, from a key index table, the first authentication string, based at least in part on identification of the data resource associated with the request.

10. The one or more non-transitory computer-readable media of claim 8, further storing instructions that when executed cause the one or more processors to perform acts comprising:
retrieving, from a key index table, the authentication key, based at least in part on identification of the data resource associated with the request.

11. The one or more non-transitory computer-readable media of claim 8, wherein the one or more authentication parameters include at least a key index parameter, the key index parameter being a numerical value that identifies a character position within the authentication key that corresponds to a first character of the second authentication string.

12. The one or more non-transitory computer-readable media of claim 8, wherein the one or more authentication parameters include a key offset parameter, the key offset parameter corresponding to a numerical value that identifies an offset from a current character position within the authentication key to a next character position within the authentication key, a character at the next character position corresponding to a next character of the first authentication string.

13. The one or more non-transitory computer-readable media of claim 8, wherein the one or more authentication parameters include a key length parameter, the key length parameter corresponding to a numerical value that identifies a number of characters associated with the first authentication string.

14. The one or more non-transitory computer-readable media of claim 8, wherein the anti-tampering data packet further includes a set of computational instructions that automatically decouple the protected data resource from the authentication key in response verifying the first authentication string associated with the authentication key, based at least in part on the authentication parameters, and
wherein granting the recipient device with access to the data resource further includes automatically executing the set of computational instructions.

15. The one or more non-transitory computer-readable media of claim 8, wherein the anti-tampering data packet further includes the first authentication string associated with the data resource.

16. A system comprising:
one or more processors;
memory coupled to the one or more processors, the memory including one or more modules that are executable by the one or more processors to:
transmit, to a sending device, a request to access a data resource associated with the sending device;
receive a protected data resource and an anti-tampering data packet, the protected data resource corresponding to a mathematical combination of an authentication key and the data resource, the anti-tampering data packet including at least one or more authentication parameters and a first authentication string;
identify the authentication key associated with the protected data resource;
determine, a second authentication string based at least in part on the authentication key and the one or more authentication parameters;
verifying that the second authentication string matches the first authentication string; and
grant access to the data resource.

17. The system of claim 16, wherein the one or more modules are further executable by the one or more processors to:
transmit the authentication key to the sending device prior to transmitting the request to access the data resource.

18. The system of claim 16, wherein the one or more modules are further executable by the one or more processors to:
receive, from the sending device, the authentication key prior to transmitting the request to access the data resource.

19. The system of claim 16, wherein the anti-tampering data packet further includes a set of computational instructions that automatically decouple the protected data resource from the authentication key in response verifying that the first authentication string associated with the authentication key, based at least in part on the authentication parameters, and
wherein to grant access to the data resource further includes automatically executing the set of computational instructions.

20. The system of claim 16, wherein the authentication key comprises an alpha-numeric coding of at least one of individual pixels in a particular digital photo, a section of text from a particular publication, or an audio excerpt from a particular digital recording.
